(19) United States
(12) Patent Application Publication
(10) Pub. No.: US 2025/0035914 A1
(43) Pub. Date: Jan. 30, 2025

(54) LOCKING ADJUSTMENT ASSEMBLY FOR AN OPTICAL SIGHT AND METHOD

(71) Applicant: PRIMARY ARMS, L.L.C., Houston, TX (US)

(72) Inventor: Robert E. Sheets, JR., Houston, TX (US)

(21) Appl. No.: 18/781,932

(22) Filed: Jul. 23, 2024

Related U.S. Application Data
(60) Provisional application No. 63/528,873, filed on Jul. 25, 2023.

(51) Int. Cl. G02B 23/16; F41G 1/38

(52) U.S. Cl. CPC G02B 23/16; F41G 1/38

(57) ABSTRACT

The disclosure is directed to a locking adjustment assembly for an optical sight. The locking adjustment assembly is configured to be set at a zero locked position, adjusted from the zero locked position to a desired unlocked position and returned to the zero locked position. The locking adjustment assembly includes a biased locking member and a biased unlocking member that are configured to be adjusted about a rotational axis of the locking adjustment assembly and adjusted along the rotational axis to establish a desired zero locked position of the locking adjustment assembly.

### CROSS-REFERENCE TO RELATED APPLICATIONS

This application claims benefit of U.S. Provisional Patent Application Ser. No. 63/528,873, filed on Jul. 25, 2023, the content of which is hereby incorporated by reference in its entirety.

### BACKGROUND OF THE DISCLOSURE

### 1. Field of the Disclosure

This disclosure relates generally in the field of manual adjustments for optical sights such as riflescopes, telescopes or other optical devices.

### 2. Background Art

An optical sight such as a riflescope for a firearm is often equipped with one or more turnable adjustment knobs (commonly referred to as “turret knobs,” “turrets” or “adjustment turrets”) that are used to adjust settings such as elevation, e.g., an elevation turret, and windage, e.g., a windage turret, affecting the respective vertical and horizontal aim of the firearm. As an example, due to gravitational forces the angular position of a riflescope with respect to a rifle barrel must be adjusted to compensate for changes in bullet drop to accurately hit a target at varying distances. As such, shooters often establish a baseline or “zero position” for a rifle by adjusting the elevation turret of the rifle's riflescope so that the point of impact of bullets fired from the rifle hit a target at a known distance according to a reticle of the riflescope thereby establishing a zero angular position of the riflescope and a baseline setting or “zero position” for the elevation turret of the riflescope. Common distances for establishing a zero position for a riflescope and elevation turret include, but are not limited to short distances such as fifty (50.0) meters, fifty (50.0) yards, one hundred (100.0) meters and one hundred (100.0) yards from a riflescope. Such a distance may be referred to herein as a “zero distance” When firing bullets at targets further away than a zero distance, the elevation turret may be adjusted to compensate for an increase in bullet drop. Afterward, the elevation turret may be reset back to a zero position (or “zero point” or “zero location”) as desired.

Some commercially available turrets allow for a riflescope to be reset to a zero position by providing a stop type mechanism for stopping rotation of a turret at a zero position. Some commercially available turrets allow for a riflescope to be set to a locked zero position. However, such turrets typically include mechanisms susceptible to failure over time and/or require an outer knob or cap (“turret cap”) for operation and/or include depressible buttons disposed along a turret cap. Also, zero stop mechanisms of some turrets may be overcome, whereby, due to the threaded nature of turrets, over rotation of a turret may result in overtightening of the turret or binding of a turret's internal threads.

Overcoming the above shortcomings is desired.

### SUMMARY OF THE DISCLOSURE

The present disclosure provides a turret assembly for an optical sight, comprising (1) a locking member; and (2) a locking surface for the locking member; wherein the locking member is biased toward the locking surface; wherein the locking surface is biased toward the locking member; wherein the locking surface is adjustable about a rotational axis of the turret assembly and adjustable along the rotational axis of the turret assembly; and wherein the locking member is adjustable about the rotational axis of the turret assembly and adjustable along the rotational axis of the turret assembly.

The present disclosure also provides a turret assembly for an optical sight, comprising (1) a pivotal locking lever; and (2) an unlocking member comprising a locking surface for the pivotal locking lever; wherein the pivotal locking lever is biased toward the unlocking member; wherein the unlocking member is biased toward the pivotal locking lever; wherein the unlocking member is adjustable about a rotational axis of the turret assembly and adjustable along the rotational axis of the turret assembly; and wherein the pivotal locking lever is adjustable about the rotational axis of the turret assembly and adjustable along the rotational axis of the turret assembly.

The present disclosure also provides a turret assembly for an optical sight, comprising (1) a locking system including (a) an unlocking collar assembly; and (b) a locking lever assembly; wherein the locking lever assembly comprises a pivotal locking lever biased toward the unlocking collar assembly; wherein the unlocking collar assembly comprises an unlocking collar biased toward the locking lever assembly; and wherein the unlocking collar assembly may be set to one or more locked positions with the locking lever assembly and set to one or more unlocked positions with the locking lever assembly.

### BRIEF DESCRIPTION OF THE SEVERAL VIEWS OF THE DRAWING

FIG. 1 is a perspective view of an embodiment a turret assembly of the present disclosure set in a locked position.

FIG. 2 is a side cross-sectional view of the turret assembly of FIG. 1.

FIG. 3 is a side cross-sectional view of the turret assembly of FIG. 1.

FIG. 4 is a side cross-sectional view of an embodiment of a turret assembly of the present disclosure set in a locked position.

FIG. 5 is a side cross-sectional view of the turret assembly of FIG. 4.

FIG. 6 is a perspective view of the turret assembly of FIG. 1.

FIG. 7 is a perspective view of the turret assembly of FIG. 1.

FIG. 8 is a perspective view of an embodiment of a click ring of a turret assembly of the present disclosure.

FIG. 9 is a side view of an embodiment of an embodiment of a click detent of a turret assembly of the present disclosure.

FIG. 10 is a perspective view of an unlocking collar of the turret assembly of FIG. 1.

FIG. 11 is a perspective view of the unlocking collar of FIG. 10.

FIG. 12 is a perspective view of the turret assembly of FIG. 1 set in an unlocked position.

FIG. 13 is a perspective view of part of the turret assembly of FIG. 1.

FIG. 14 is a perspective cross-sectional view of the turret assembly of FIG. 1.

FIG. 15 is a side cross-sectional view of part of the turret assembly of FIG. 1.

FIG. 16 is a perspective view of an embodiment of a secondary jacking screw support member of a turret assembly of the present disclosure.

FIG. 17 is a perspective view of an embodiment of an annular main shaft member of a turret assembly of the present disclosure.

FIG. 18 is a perspective view of an embodiment of a secondary jacking screw of a turret assembly of the present disclosure.

FIG. 19 is a perspective view of the secondary jacking screw of FIG. 18.

FIG. 20 is a side cross-sectional partial view of the turret assembly of FIG. 1 set in a locked position.

FIG. 21 is a side cross-sectional partial view of the turret assembly of FIG. 1 set in an unlocked position.

FIG. 22 is a perspective partial view of the turret assembly of FIG. 1 set in a locked position.

FIG. 23 is a side cross-sectional partial view of the turret assembly of FIG. 1 set in a locked position.

FIG. 24 is a side cross-sectional view of the turret assembly of FIG. 1 set in an unlocked position.

FIG. 25 is a side cross-sectional view of an embodiment of a turret assembly of the present disclosure.

FIG. 26 is a perspective cross-sectional view of the turret assembly of FIG. 25.

FIG. 27 is a perspective view of an unlocking collar of the turret assembly of FIG. 25.

FIG. 28 is a perspective view of the unlocking collar of FIG. 27.

FIG. 29 is a side cross-sectional view of an embodiment of a turret assembly of the present disclosure set in a locked position.

FIG. 30 is a perspective exploded view of an embodiment of an annular main shaft member and a key member of an embodiment of a turret assembly of the present disclosure.

FIG. 31 is a perspective view of an embodiment of a first jacking screw of an embodiment of a turret assembly of the present disclosure.

FIG. 32 is a perspective view of the annular main shaft member of FIG. 30 including a key member mated thereto.

FIG. 33 is a perspective view of an embodiment of a secondary jacking screw of an embodiment a turret assembly of the present disclosure.

FIG. 34 is a perspective view of an embodiment of an optical sight including an embodiment of an elevation turret assembly and an embodiment of a windage turret assembly of the present disclosure.

FIG. 35 is a perspective view of an embodiment of an optical sight including an embodiment of an elevation turret assembly and an embodiment of a windage turret assembly of the present disclosure.

### DEFINITIONS USED IN THE DISCLOSURE

The term “at least one”, “one or more”, and “one or a plurality” mean one thing or more than one thing with no limit on the exact number; these three terms may be used interchangeably within this disclosure. For example, at least one device means one or more devices or one device and a plurality of devices.

The term “about” means that a value of a given quantity is within +20% of the stated value. In other embodiments, the value is within +15% of the stated value. In other embodiments, the value is within +10% of the stated value. In other embodiments, the value is within +7.5% of the stated value. In other embodiments, the value is within +5% of the stated value. In other embodiments, the value is within +2.5% of the stated value. In other embodiments, the value is within +1% of the stated value.

The term “substantially” or “essentially” means that a value of a given quantity is within +10% of the stated value. In other embodiments, the value is within +7.5% of the stated value. In other embodiments, the value is within +5% of the stated value. In other embodiments, the value is within +2.5% of the stated value. In other embodiments, the value is within +1% of the stated value. In other embodiments, the value is within +0.5% of the stated value. In other embodiments, the value is within +0.1% of the stated value.

The term “and/or” includes any and all combinations of one or more of the associated listed items.

### DETAILED DESCRIPTION OF THE DISCLOSURE

For the purposes of promoting an understanding of the principles of the disclosure, reference is now made to the embodiments illustrated in the drawings and particular language will be used to describe the same. It is understood that no limitation of the scope of the claimed subject matter is intended by way of the disclosure.

The terms “first,” “second,” “third,” and the like, herein do not denote any order, quantity, or importance, but rather are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable. For example, in some circumstances, an event or capacity can be expected, while in other circumstances, the event or capacity cannot occur. This distinction is captured by the terms “may” and “may be.”

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like.

It is to be understood that the present disclosure is not limited to particular embodiments. It is also to be understood that the terminology used herein is for the purpose of describing particular embodiments only, and is not intended to be limiting. Herein, the term “optical sight” may be used interchangeably with the terms “scope,” “scope sight,” “optical platform,” “sight system,” “telescopic sight,” “optical aiming device,” and “viewing optic.” Herein, the terms “locking adjustment assembly,” “turret assembly,” “turret knob assembly” and “locking turret assembly” may be used interchangeably. Herein, a person using a locking adjustment assembly of this disclosure may be referred to as a “user,” an “operator” or as a “shooter.” Herein, manual operation of a locking adjustment assembly may be accomplished via a user's hand(s), a user's finger(s), by way of a hand held tool or instrument, and combinations thereof. Herein, a “reticle” in relation to optical sights refers to a pattern of lines and/or markings located on an eyepiece of an optical sight used to assist a shooter in aiming and/or targeting and/or measuring targets that are viewed through the eyepiece. A non-limiting example of a reticle is provided in U.S. Pat. No. 10,648,771 B2, titled “Firearm Reticle,” issued on May 12, 2020; which is herein incorporated by reference in its entirety.

Herein. “MIL” or “MRAD” is a shortening of the term milliradian and “MILs” and “MRADs” is a shortening of milliradians. A milliradian is an angular measurement wherein a milliradian is a thousandth of a radian. There are 6.283 radians in a circle, which equates to 6283.0 milliradians in a circle. As understood by the skilled artisan, milliradians are used in the adjustment of firearm sights by adjusting the angle of a sight compared to the barrel of a corresponding firearm. For purposes of this disclosure, “milliradian,” “MIL” and “MRAD” can be used interchangeably.

Herein, “MOA” refers to Minutes of Angle, which is an angular measurement wherein one minute of angle is equal to 1/60 of a degree. As understood by the skilled artisan, the term “subtension” refers to the amount of a target that is covered by some part of a reticle. Subtension may be measured in length at a specific distance (inches at a distance in yards) or as an angular measurement in MRAD or MOA.

As used in this disclosure, a “projectile launching device” may include, but is not necessarily limited to a firearm, a bow, and a crossbow. Herein, the term “firearm” may include, but is not limited to a pistol, a semiautomatic firearm, e.g., a semiautomatic rifle, a bolt action firearm, e.g., a bolt action rifle, a shotgun, a revolver, a shoulder fired bazooka, a shoulder fired rocket launcher, an air rifle, and a paintball gun. As understood by a person skilled in the art of firearms and/or firearm shooting (a “skilled artisan”), a particular firearm may be provided in different barrel lengths. Non-limiting examples of pistols are provided in U.S. Pat. No. 4,539,889, titled “Automatic Pistol with Counteracting Spring Control Mechanism,” issued on Sep. 10, 1985; and United States Patent Number U.S. D918,328 S, titled “Handgun,” issued on May 4, 2021, each of which is herein incorporated by reference in its entirety. Non-limiting examples of semiautomatic rifles are provided in U.S. Pat. No. 9,777,975 B2, titled “Semiautomatic Firearm,” issued on Oct. 3, 2017; and U.S. Pat. No. 7,775,150 B2, titled “Law Enforcement Carbine with One Piece Receiver,” issued on Aug. 17, 2010, each of which is herein incorporated by reference in its entirety. Non-limiting examples of a bolt action firearm are provided in U.S. Pat. No. 8,925,234 B1, titled “Bolt Action Rifle with Safety Latching Mechanism,” issued on Jan. 6, 2015; and U.S. Pat. No. 8,397,416 B2, titled “Multi-Caliber Bolt-Action Rifle and Components,” issued on Mar. 19, 2013; each of which is herein incorporated by reference in its entirety.

In regard to use with rifles, an optical sight configured to mount to a rifle may also be referred to as a riflescope. In regard to use with pistols, an optical sight configured to mount to a pistol may also be referred to as a pistol scope. Suitable optical sights for use with a locking adjustment assembly of this disclosure include, but are not limited to optical sights as described in U.S. Pat. No. 10,180,565 B2 titled “Viewing Optic with an Integrated Display System,” issued on Jan. 15, 2019, which is herein incorporated by reference in its entirety; and United States Patent Application Publication Number US 2011/0314720 A1 titled “Rubber Armored Rifle Scope with Integrated External Laser Sight,” published on Dec. 29, 2011, which is herein incorporated by reference in its entirety.

Herein, the term “firearm load” refers to a unit of ammunition that includes a cartridge case, primer, powder and bullet. The term “bullet drop” refers to the curved trajectory traversed by a moving projectile, e.g., a bullet, as it falls from its initial trajectory while traveling a distance. i.e., “target range” or “target distance,” from a projectile launching device to a target. As understood by the skilled artisan, bullet drop is caused by the influence of gravity on a moving projectile or bullet. Therefore, to hit a target at long range, it is necessary to elevate the barrel of a firearm and the aiming point to compensate for bullet drop. The term “full value wind” refers to wind blowing perpendicular left to right or right to left in relation to a reticle and user thereof, e.g., a cross wind. Using a clock system, full value winds travel “9 to 3” and “3 to 9” in relation to a reticle and user thereof. As also understood by the skilled artisan, the term “full value” in reference to wind means that the force of the wind has a full effect on the flight of a bullet compared to a “half value wind” or “no value wind” As further understood by the skilled artisan, generally, the greater the velocity of wind the greater its force.

In an embodiment, the disclosure is related to a locking adjustment assembly for an optical sight mounted to a projectile launching device, the locking adjustment assembly having a low profile design. In an embodiment, the locking adjustment assembly may be compact and/or lightweight and/or dimensionally scalable.

In an embodiment, the disclosure is related to a locking adjustment assembly having a zero lock configuration providing a solid stop at a defined zero position of the locking adjustment assembly.

In an embodiment, the disclosure is related to a locking adjustment assembly with a tactile automatic lock at a zero setting of the locking adjustment assembly. The locking adjustment assembly is mechanically lockable and can be manually unlocked by an individual when a change in setting of the locking adjustment assembly is desired.

In an embodiment, the disclosure is related to a locking adjustment assembly including an adjustable unlocking member assembly and a locking lever assembly comprising a biased contact surface for setting the locking adjustment assembly at a zero position against one or more biased contact surfaces of the adjustable unlocking member assembly. In an embodiment, the lever assembly includes a pivotal locking lever, or pivotal locking cam, having one or more contact surfaces planarly parallel or substantially planarly parallel to an axis of rotation of the pivotal locking lever.

In an embodiment, the disclosure is related to a locking adjustment assembly comprising a configuration for re-zeroing the locking adjustment assembly without the use of shims, winding or other complicated steps or procedures.

In an embodiment, the disclosure is related to a locking adjustment assembly including allowable clicks past a zero position of the locking adjustment assembly.

In an embodiment, the disclosure is related to a locking adjustment assembly comprising a built in stop mechanism effective to provide for a desired number of allowable clicks past a zero position of the locking adjustment assembly.

In an embodiment, the disclosure is related to a locking adjustment assembly with dual jacking screws configured in a manner whereby the locking adjustment assembly may be used with one or more optical platforms including a plurality of different optical platforms.

In an embodiment, the disclosure is related to a locking adjustment assembly including a plurality of moveable members rotatable about a common axis and a plurality of fixed members, wherein rotation of the moveable members changes the linear position of the moveable members, wherein the locking adjustment assembly may be adjusted to provide a desired starting locked position of the locking adjustment assembly.

In an embodiment, the disclosure is related to a locking adjustment assembly including (1) an adjustable assembly defining a rotational axis of the locking adjustment assembly and configured to be directed linearly linear along the rotational axis; and (2) a pivotal lever type locking assembly configured to engage at least part of the adjustable assembly providing a locked position of the locking adjustment assembly; wherein the locked position of the lever type locking assembly defines a zero locked position of the locking adjustment assembly.

In an embodiment, the disclosure is related to a locking adjustment assembly including an adjustable assembly and a nonadjustable assembly defining a rotational axis of the locking adjustment assembly, wherein the adjustable assembly includes an unlocking collar assembly and wherein the nonadjustable assembly includes a locking lever assembly wherein the unlocking collar assembly is configured to be disengaged from the locking lever assembly providing an unlocked position of the locking adjustment assembly.

In an embodiment, the disclosure is related to a locking adjustment assembly having a pivotal locking member for engaging an adjustable member of the locking adjustment assembly that is rotationally adjustable about a rotational axis of the locking adjustment assembly and linearly adjustable along the rotational axis.

In an embodiment, the disclosure is related to a locking adjustment assembly comprising threaded members providing linear movement of the locking adjustment assembly, wherein the threaded members are configured for use across different optical platforms.

In an embodiment, the disclosure is related to a method for adjusting elevational settings of an optical sight using a locking adjustment assembly as described herein. The present disclosure is also related to a method for adjusting windage settings of an optical sight using a locking adjustment assembly as described herein.

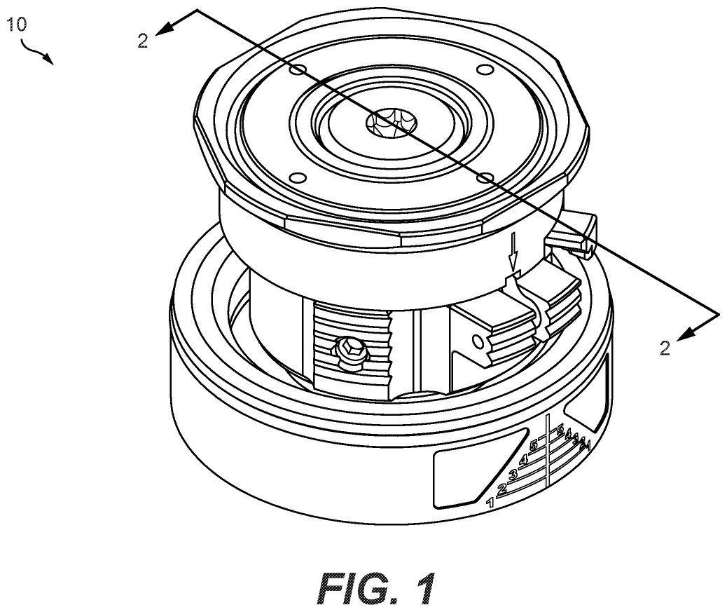

With reference to FIGS. 1-3, an embodiment of a locking adjustment assembly 10 for use with an optical sight 8 is provided. As described herein, the locking adjustment assembly 10 (hereafter “turret assembly 10”) includes a plurality of members configured to move when the turret assembly 10 is manipulated for purposes of adjusting a reticle of a corresponding optical sight 8. The turret assembly 10 also includes a plurality of members configured to hold in a fixed position when the turret assembly 10 is manipulated for purposes of adjusting a reticle of a corresponding optical sight 8. Herein, the plurality of members of a turret assembly 10 configured to move when the turret assembly 10 is manipulated to adjust a reticle of a corresponding optical sight 8 may be referred to as an “adjustable assembly” of the turret assembly 10 and the plurality of members configured to hold in a fixed position when the turret assembly 10 is manipulated to adjust a reticle may be referred to as a “nonadjustable assembly” of the turret assembly 10. Although a turret assembly 10 as depicted in FIGS. 1-3 may be used with an optical sight 8 for purposes of elevation adjustment and/or windage adjustment of a reticle of an optical sight 8, a turret assembly 10 as provided in FIGS. 1-3 is described in terms of elevation adjustment for a reticle of an optical sight 8.

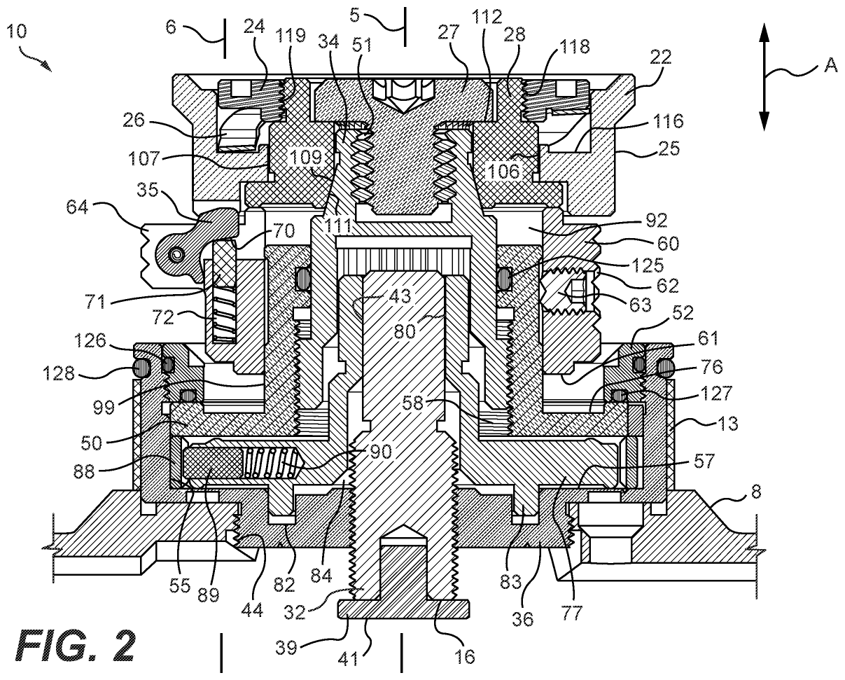

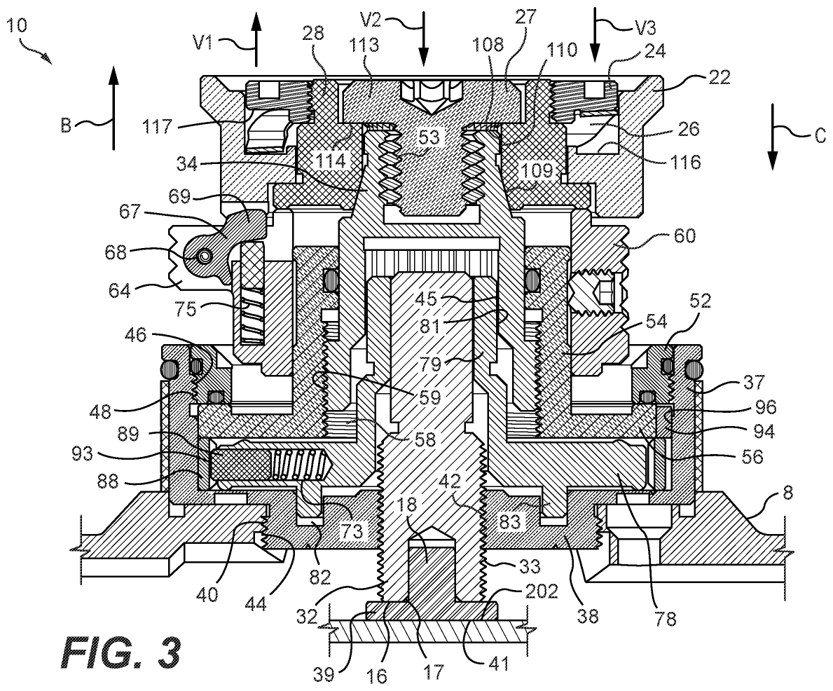

With reference to FIGS. 2 and 3, an adjustable assembly of a turret assembly 10 may comprise at least an unlocking member 22 (or “unlocking collar 22”), a retaining ring member 24 (or “retaining ring 24”), one or more biasing members 26, an annular socket member 28, a primary threaded fastener 27 (or “primary fastener 27”), a first adjustment member 32 (or “jacking screw 32”), a second adjustment member 34 (or “secondary jacking screw 34”), and an annular main shaft member 77 (or “main shaft 77”). A nonadjustable assembly of a turret assembly 10 may comprise at least an annular turret assembly base member 36 (or “base member 36”), a secondary jacking screw support member 50, a lock ring 52, and a locking lever carrier member 60. As described herein, each member of the adjustable assembly is configured to rotate about a rotational axis 5 of the turret assembly 10 clockwise and counterclockwise when the turret assembly 10 is manipulated in either direction. Each member of the adjustable assembly is also configured to travel linearly along the rotational axis 5 in either direction (see directional arrow A in FIG. 2) according to the direction of rotation of the turret assembly 10. For purposes of this disclosure, an unlocking collar 22, a retaining ring 24, one or more biasing members 26, a socket member 28, and a primary fastener 27 of an adjustable assembly may collectively be referred to herein as an “unlocking member assembly” or “unlocking collar assembly” of a turret assembly 10.

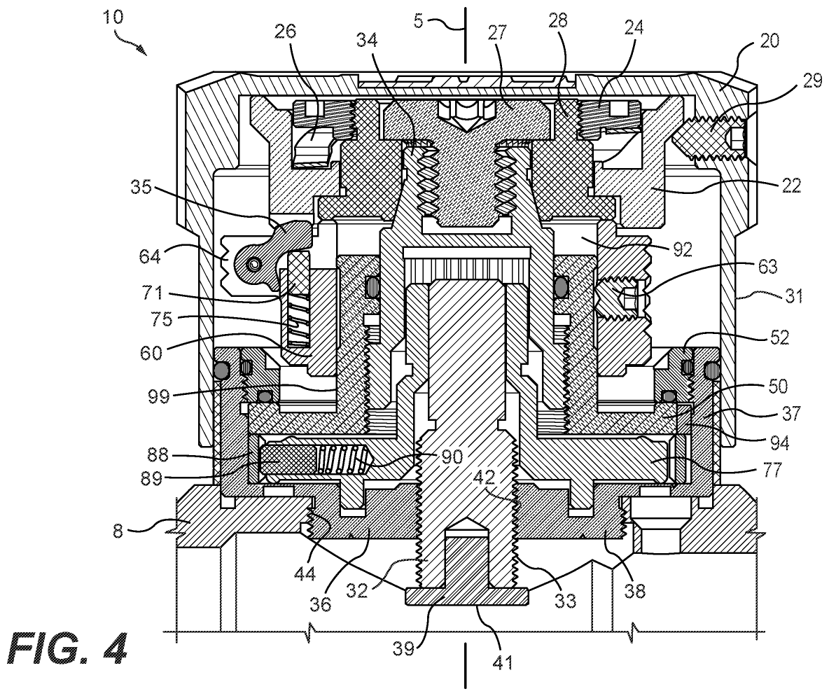

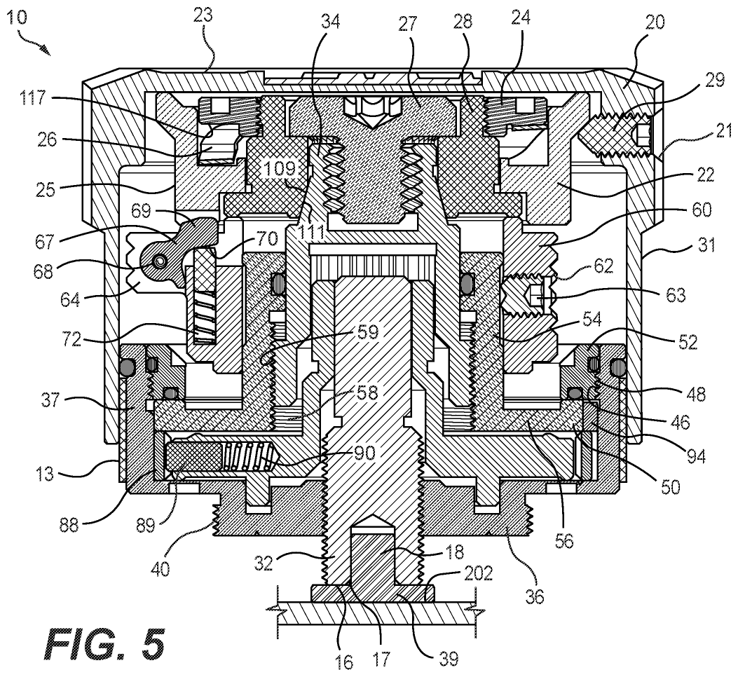

As stated above, an adjustable assembly as shown in FIGS. 2 and 3 is configured to move when the turret assembly 10 is manipulated to adjust a reticle of a corresponding optical sight 8. As such, an unlocking collar 22 of an adjustable assembly as shown in FIGS. 2 and 3 includes an outer surface 25 having a surface area suitable for manual turning of the unlocking collar 22 clockwise and counterclockwise for purposes of adjusting a reticle of a corresponding optical sight 8. As such, in an embodiment an unlocking collar 22 may be referred to as a “manual adjustment member” of a turret assembly 10. Turning to FIGS. 4 and 5, in another embodiment a turret assembly 10 may further include a cap member 20 (or “turret cap 20”) removably attachable to the unlocking collar 22 wherein the turret cap 20 may be employed as a manual adjustment member of the turret assembly 10. In an embodiment of a turret assembly 10 comprising a turret cap 20 as shown in FIGS. 4 and 5, an unlocking collar 22 may also be referred to as a “turret cap seat 22” and a socket member 28 may also be referred to as a “turret cap hub 28.”

With further reference to FIGS. 4 and 5, in an embodiment a turret cap 20 may include a cover 23 and a cylindrical sidewall 31 extending out from a perimeter of the cover 23 enveloping or otherwise covering all or a majority of the members of the turret assembly 10. Suitably, the sidewall 31 includes one or more radially disposed threaded apertures 21 for receiving one or more threaded fasteners 29 (or “turret cap set screws 29”) there through in a manner effective to fixedly secure the turret cap 20 to the unlocking collar 22 to promote rotation of the jacking screw 32 and the secondary jacking screw 34 when the turret cap 20 is turned about the rotational axis 5. In an embodiment as depicted in FIGS. 4 and 5, an adjustable assembly as described above may further include a turret cap 20.

In an embodiment, a turret assembly 10 of this disclosure may be permanently attached to an optical sight 8. In another embodiment, a turret assembly 10 of this disclosure may be removably attached to an optical sight 8. With reference to FIGS. 2 and 3, in an embodiment a base member 36 may be configured as a base member of a turret assembly 10. For example, a base member 36 may include a spigot portion 38 (or “spigot 38”) and a cylindrical pocket member portion 37 (or “pocket member 37”) configured to hold at least part of the adjustable assembly and one or more other members of the nonadjustable assembly therein. In an embodiment as depicted, the spigot 38 may include an outer threaded surface 40 for threaded communication with an inner threaded surface 44 of an optical sight 8 wherein a turret assembly 10 may be operably threaded to an optical sight 8 wherein a central axis of the base member 36 defines the rotational axis 5.

As shown, the spigot 38 may include an opening having an inner threaded surface 42 for threaded communication with an outer threaded surface 33 of the jacking screw 32 whereby the base member 36 is configured as a threaded anchor member for linear travel of the jacking screw 32 along the rotational axis 5 as the turret assembly 10 is turned clockwise and counterclockwise. The main shaft 77 may also include a cylindrical portion 79 defining an opening 84 axially aligned with the inner threaded surface 42 along the rotational axis 5 for receiving at least part of the jacking screw 32 as shown. In an embodiment, a splined inner surface 80 of the main shaft 77 is rotationally linked to a splined outer surface 43 of the jacking screw 32 in a manner effective for the jacking screw 32 to be directed linearly along the rotational axis 5 relative the main shaft 77 during operation according to the configuration of the splined inner surface 80 and the splined outer surface 43, i.e., the splined outer surface 43 of the jacking screw 32 may be slid along the splined inner surface 80 of the main shaft 77 during operation. The cylindrical section 79 of the main shaft 77 may also include a splined outer surface 81 rotationally linked to a splined inner surface 45 of the secondary jacking screw 34 in a manner effective for the secondary jacking screw 34 to be directed linearly along the rotational axis 5 relative the main shaft 77 during operation according to the configuration of the splined outer surface 81 and the splined inner surface 45, i.e., the splined inner surface 45 of the secondary jacking screw 34 may be slid along the splined outer surface 81 of the main shaft 77 during operation.

The spigot 38 also includes an annular channel 82 at a depth effective to receive at least part of a main shaft 77 therein. In this embodiment, the main shaft 77 includes a ring portion 78 having an annular protruding member 83 configured to mate with the annular channel 82 in a manner effective to turn freely within the annular channel 82 during turret assembly 10 operation, wherein the annular channel 82 is configured to maintain a proper axial alignment of the main shaft 77 during operation.

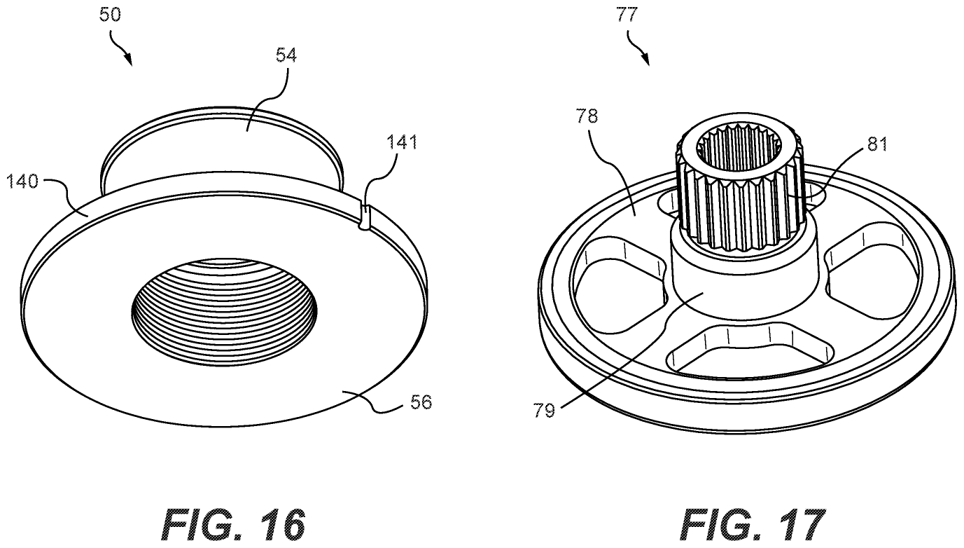

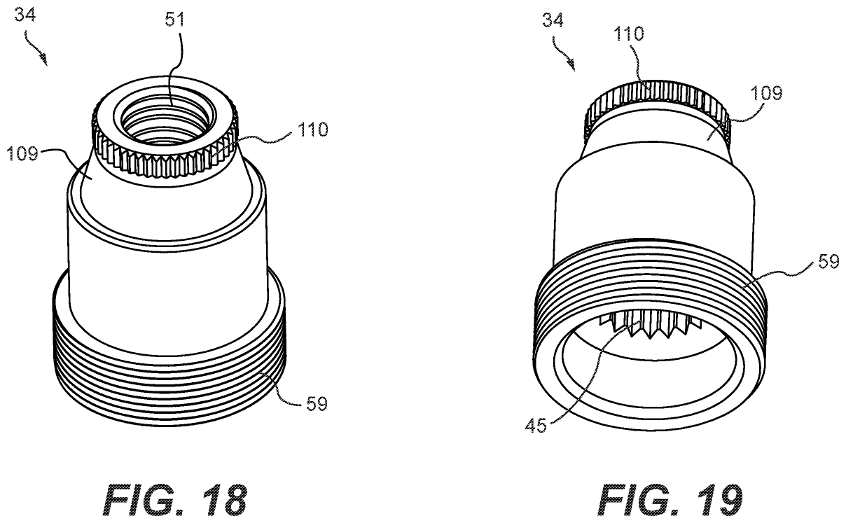

Still referring to FIGS. 2 and 3, a turret assembly 10 may also include a secondary jacking screw support member 50 fixedly secured to the pocket member 37 of the main seat member 36 via a lock ring 52 and at least one locating pin 94 in a manner effective to retain the main shaft 77 in a mated position with the base member 36. In an embodiment, a ring portion 56 of the secondary jacking screw support member 50 may be disposed parallel and adjacent the ring portion 78 of the main shaft 77 wherein the ring portion 56 is fixedly secured to the pocket member 37 of the base member 36 via at least one locating pin 94 disposed between the pocket member 37 and the ring portion 56 of the secondary jacking screw support member 50 as shown. As depicted in FIG. 16, in an embodiment an outer perimeter 140 of a ring portion 56 of a secondary jacking screw support member 50 may include at least one mating surface 141 such as a groove or the like configured to receive a first part of the at least one locating pin 94 therein. Likewise, an inner surface 55 of the pocket member 37 may include at least one mating surface 96 such as a groove or splined surface configured to receive an opposing second part of the at least one locating pin 94 therein. As shown, the pocket member 37 of the base member 36 also includes an inner threaded surface 46 for threaded communication with an outer threaded surface 48 of a lock ring 52 wherein the lock ring 52 is configured to be threaded onto the base member 36 in a manner effective to prevent or otherwise minimize linear travel of the secondary jacking screw support member 50 and the main shaft 77 along the rotational axis 5 during turret assembly 10 operation. As such, a lock ring 52 of this disclosure may also be referred to herein as a “secondary jacking screw support member lock ring 52.” Still referring to FIGS. 2 and 3, a secondary jacking screw support member 50 may also include a cylindrical portion 54 with an inner threaded surface 58 for threaded communication with an outer threaded surface 59 of a first end of the secondary jacking screw 34 wherein the secondary jacking screw support member 50 is configured as a threaded anchor member for linear travel of the secondary jacking screw 34 along the rotational axis 5 as the turret assembly 10 is turned clockwise and counterclockwise.

Suitably, the ring portion 78 of the main shaft 77 is disposed between the spigot 38 of the base member 36 and the ring portion 56 of the secondary jacking screw support member 50 in a manner effective for the main shaft 77 to be turned about the rotational axis 5 clockwise and counterclockwise for operation with a click ring 88 of the turret assembly 10 that is disposed adjacent the outer perimeter of the ring portion 78 as shown. Looking at FIGS. 2 and 3, in an embodiment a click ring 88 may be press fit, glued, fastened, secured via one or more pin members, or threaded within the pocket member 37 of the base member 36 against the inner surface 55 of the pocket member 37 and against or near an inner surface 57 of the spigot 38 of the base member 36 as shown. Herein, the inner surface 57 may also be referred to as a “floor 57” of the main seat member 36. In this embodiment, the ring portion 78 of the main shaft 77 includes a radial borehole 73 for housing a plunger 89 (or “click pin 89” or “click detent 89”) and at least one biasing member 90 that is configured to bias the click detent 89 radially outward to an abutment position with the click ring 88 along the length of the click ring 88 as the main shaft 77 is turned about the rotational axis 5 clockwise and counterclockwise during operation of the turret assembly 10. In an embodiment, the at least one biasing member 90 may include at least one coiled spring (or “detent spring 90”). In an embodiment, the inner surface of the click ring 88 may include a plurality of ridges 91A and grooves 91B (see FIG. 8) for receiving a distal end 93 of the click detent 89 (see FIG. 9) between adjacent ridges 91A. In an embodiment, a distal end 93 of click detent 89 may include a planar end type surface as shown in FIGS. 2 and 3. In another embodiment as depicted in FIG. 9, a distal end 93 of the click detent 89 may include a tapered surface, e.g., wedge shaped surface, promoting linear movement of the click detent 89 back and forth as the distal end 93 rides over the ridges 91A and grooves 91B of the click ring 88. In another embodiment, a distal end 93 of the click detent 89 may include a conical configuration. In another embodiment, a distal end 93 of the click detent 89 may include a spherical configuration. Suitably, the click ring 88 and click detent 89 cooperate to provide audible and tactile clicks for a user as the turret assembly 10 is turned clockwise and counterclockwise. At a resting position, the distal end 93 of the click detent 89 is biased between adjacent ridges 91A in a particular groove 91B of the click ring 88. Without limiting the disclosure to a particular number of clicks per rotation, in one non-limiting embodiment of a turret assembly 10 the click ring 88 may include a number of ridges 91A and grooves 91B providing one hundred clicks per rotation of the turret assembly 10 360.0 degrees clockwise and counterclockwise.

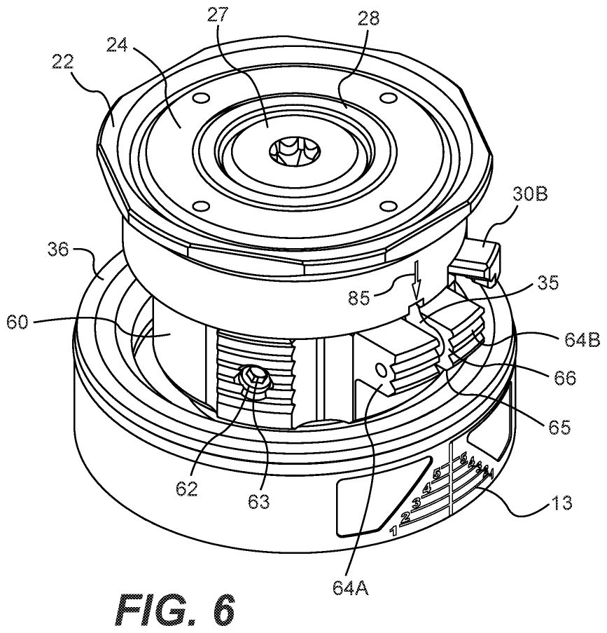

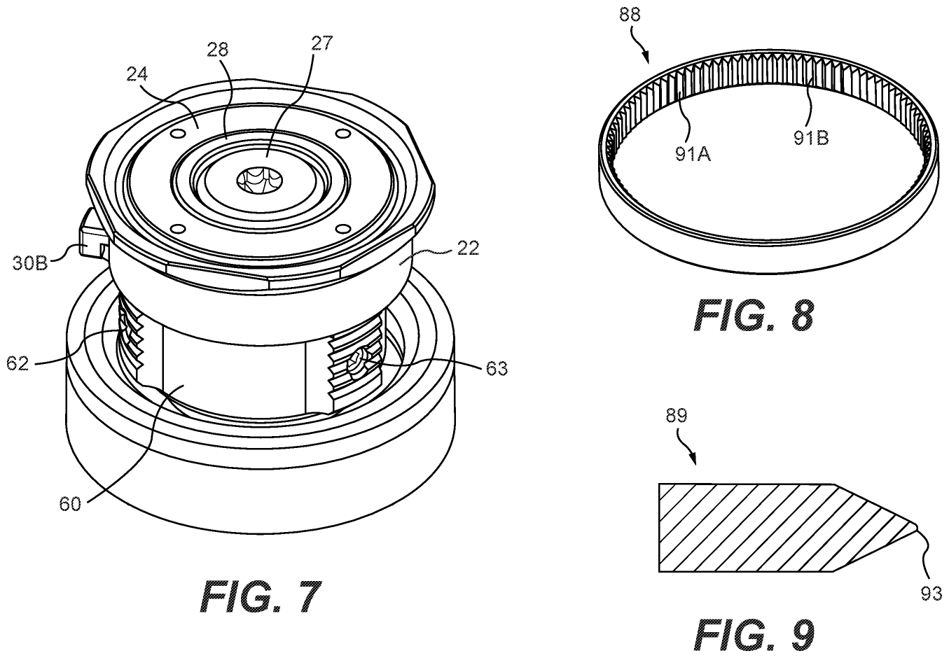

Still referring to FIGS. 2 and 3, at least part of the cylindrical portion 54 of the secondary jacking screw support member 50 is surrounded by at least part of the locking lever carrier member 60. As shown, the locking lever carrier member 60 may include a cylindrical inner surface 92 configured as a slidable contact surface for an outer surface 99 of the cylindrical portion 54 of the secondary jacking screw support member 50. The locking lever carrier member 60 also includes one or more radial threaded boreholes 62 (see also FIG. 6) for receiving one or more threaded fasteners 63, e.g., one or more threaded set screws, there through in a manner effective to fixedly secure the locking lever carrier member 60 to the secondary jacking screw support member 50 during operation of the turret assembly 10. In an embodiment, the one or more threaded fasteners 63 may also be referred to as “one or more zero stop set screws 63.”

Referring to FIG. 6, in an embodiment the locking lever carrier member 60 may include a projection 64 comprising opposing projection members 64A and 64B defining an open slot 65 between the inner sidewalls of the opposing projection members 64A and 64B (see inner sidewall 66 of projection member 64B). As shown, the slot 65 provides space for housing a locking lever member 35 (or “locking lever 35” or “locking cam 35”) of the turret assembly 10, the locking lever 35 being pivotally attached to the projection member 64A and/or the projection member 64B via at least one pivot member 68 (see FIG. 3) defining a pivot point of the locking lever 35. The locking lever 35 is radially disposed within the slot 65 and includes an elongated portion including a neck section 67 and a distal head section 69 (see FIG. 3) comprising a mating surface or mating face 70 (see FIG. 2) for contacting a biased pin member 71 (or “locking lever plunger 71”) housed within a cavity 72 of the locking lever carrier member 60 in addition to one or more corresponding biasing members 75, e.g., one or more coiled springs, one or more leaf springs, one or more flat springs, and combinations thereof. The cavity 72 includes a longitudinal axis 6 (see FIG. 2) parallel to the rotational axis 5 wherein the one or more biasing members 75 are configured to provide a biasing force (see vector arrow V1 in FIG. 3) to bias the pin member 71 linearly toward the locking lever 35 (see directional arrow B in FIG. 3) in a manner effective to pivot the face 70 of the locking lever 35 radially to a contact position with the unlocking collar 22. Herein, a contact position between the locking lever 35 and the unlocking collar 22 may include (1) a locked contact position between the locking lever 35 and the unlocking collar 22, or (2) an unlocked contact position with the unlocking collar 22. In an embodiment, the locking lever carrier member 60, including the projection 64 comprising opposing projection members 64A and 64B, the locking lever 35, the cavity 72, the pin member 71, and the one or more biasing members 75 may be collectively referred to herein as a “locking lever assembly” of the turret assembly 10.

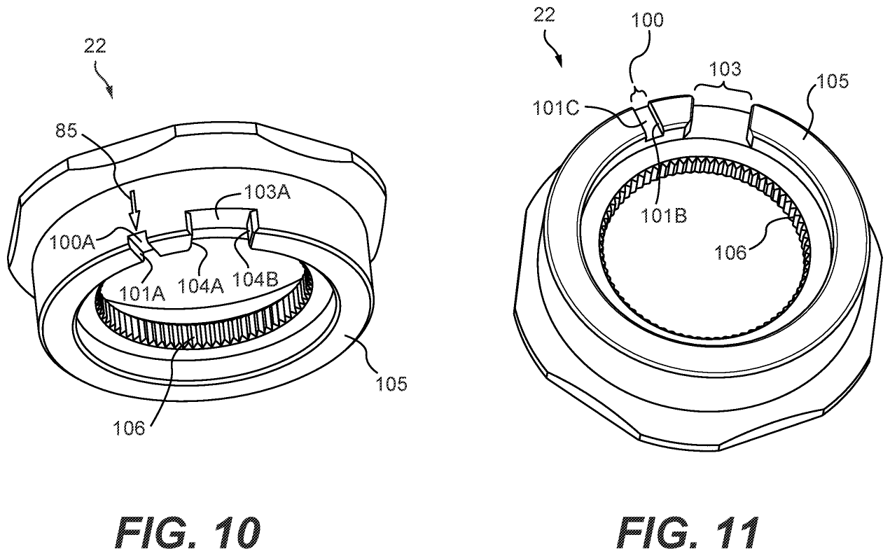

Referring to FIGS. 10 and 11, in an embodiment an unlocking collar 22 may include a locking surface including a first radially disposed slot 100 (or “locking slot 100”) defined by opposing sidewalls 101A and 101B including, but not necessarily limited to planar sidewalls for receiving at least part of the locking lever 35 therein. The unlocking collar 22 also includes an over travel stop surface including a second radially disposed slot 103 (or “over travel stop slot 103”) defined by opposing sidewalls 104A and 104B including, but not necessarily limited to planar sidewalls for receiving part of a socket member 28 therein. As described below, the locking slot 100 is configured to receive the locking lever 35 therein defining a zero locked position of the turret assembly 10 and the over travel stop slot 103 is configured to receive part of a socket member 28 therein to prevent undesired clockwise rotation of the turret assembly 10 beyond a zero position of the turret assembly 10. In an embodiment, a center point 100A of the locking slot 100 may be set apart from a center point 103A of the over travel stop slot 103 an angular distance as desired. As a non-limiting example, the angular distance from center point 100A to center point 103A may range from or about 29.0 degrees to or about 31.0 degrees. In an embodiment, a center point 100A of the locking slot 100 may be set apart from a center point 103A of the over travel stop slot 103 an angular distance of or about 30.12 degrees.

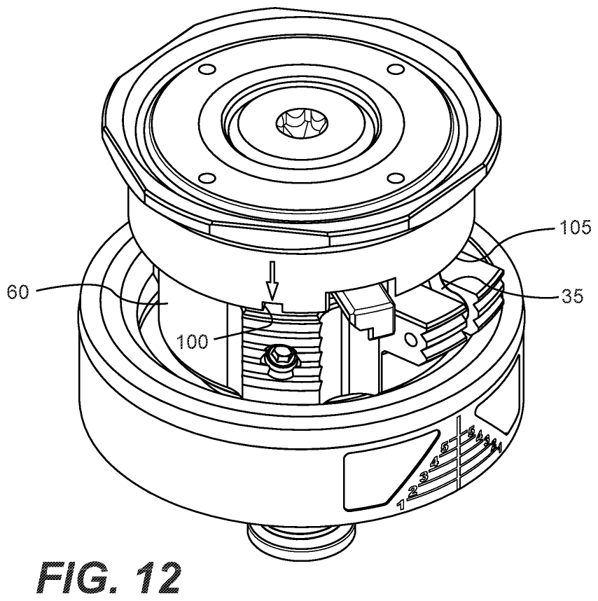

Herein, an unlocking collar assembly and a locking lever assembly as described above may collectively be referred to as a “locking system” of the turret assembly 10. As shown in FIGS. 2 and 3, at a first position (or “locked position”) of the locking system of the turret assembly 10 the locking lever 35 is biased toward a contact surface 101C (see FIG. 11) of the locking slot 100 with the head section 69 of the locking lever 35 located within the locking slot 100 between the sidewalls 101A and 101B biased against the contact surface 101C when the locking slot 100 is radially aligned with the locking lever 35 (see also FIGS. 6 and 14). At a second position (or “unlocked position”) of the turret assembly 10 the locking lever 35 is biased against an annular contact surface 105 of the unlocking collar 22 when the locking lever 35 is in a non-mated position with the locking slot 100 as shown in FIG. 12.

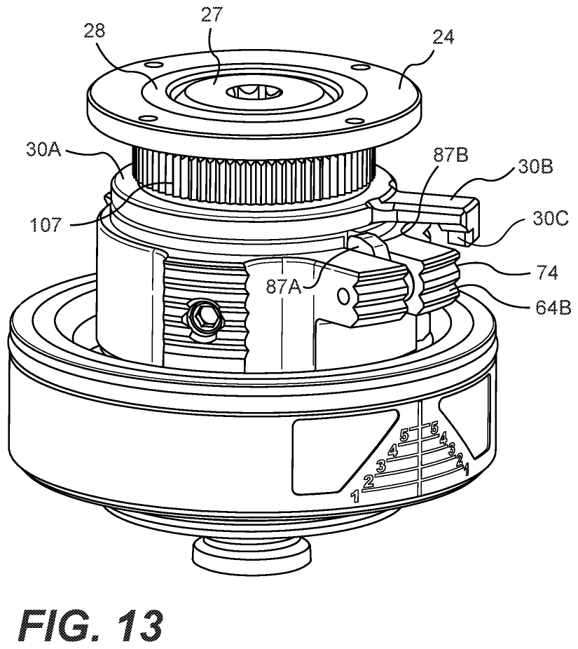

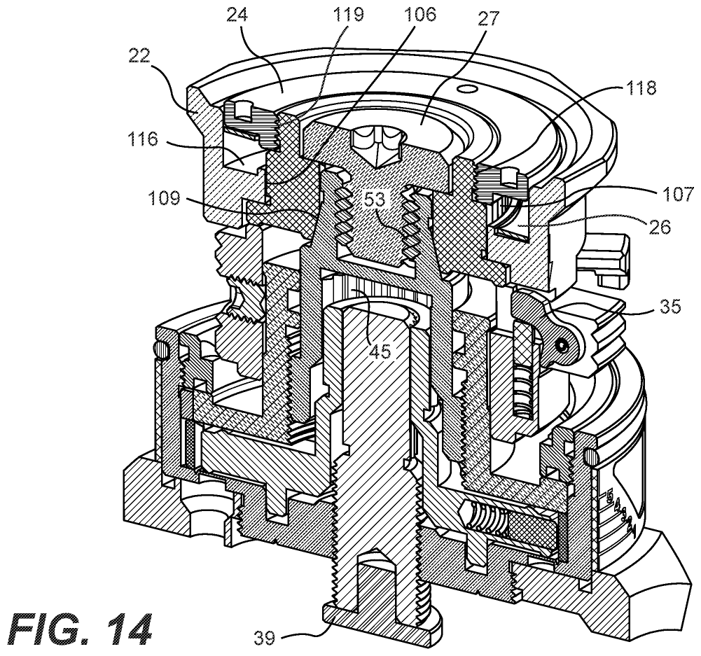

Suitably, the position of the head section 69 of the locking lever 35 within the locking slot 100 prevents rotation of the turret assembly 10 about the rotational axis 5 as the head section 69 of the locking lever 35 acts as a surface stop against the sidewalls 101A and 101B of locking slot 100. In particular, the opposing sides 87A and 87B of the locking lever 35 (see FIG. 13) are configured as abutment surfaces for the sidewalls 101A and 101B of the locking slot 100. Although the opposing sides 87A and 87B of the locking lever 35 are not limited to a particular size and/or shape, in an embodiment the opposing sides 87A and 87B may include planar engagement surfaces for engaging planar sidewalls 101A and 101B of the locking slot 100 to minimize wear to the locking lever 35 and/or the planar sidewalls 101A and 101B of the locking slot 100 from use over time. In an embodiment, the depth of the locking slot 100 suitably provides sidewalls 101A and 101B having a surface area operable as an engagement surface for the opposing sides 87A and 87B of the head section 69 of the locking lever 35 effective to prevent unwanted turning of the turret assembly 10 when the turret assembly 10 is set at a locked position.

Referring to FIGS. 2 and 3, the unlocking collar 22 is rotatably communicated with the secondary jacking screw 34 via the socket member 28 disposed between the unlocking collar 22 and a second end of the secondary jacking screw 34 as shown. In an embodiment, the unlocking collar 22 may include a splined inner surface 106 (see also FIGS. 10 and 11) matable with a splined outer surface 107 of the socket member 28 (see also FIGS. 13 and 14). As shown, the socket member 28 may also include an inner mating surface configured to mate with the second end of the secondary jacking screw 34 in a fixed position during operation of the turret assembly 10. For example, the inner mating surface of a socket member 28 may include (1) a first inner mating surface including an inner tapered or conical inner surface 111 (see FIG. 2) configured as a mating surface for conical outer surface 109 of the secondary jacking screw 34 and/or (2) a second inner mating surface including an inner splined surface 108 configured as a mating surface with an outer splined surface 110 of the secondary jacking screw 34 (see FIG. 3). The interconnection between the unlocking collar 22, the socket member 28 and the second end of the secondary jacking screw 34 enables the unlocking collar 22, the socket member 28 and the secondary jacking screw 34 to turn clockwise and counterclockwise as a fixed assembly about the rotational axis 5 during operation of the turret assembly 10.

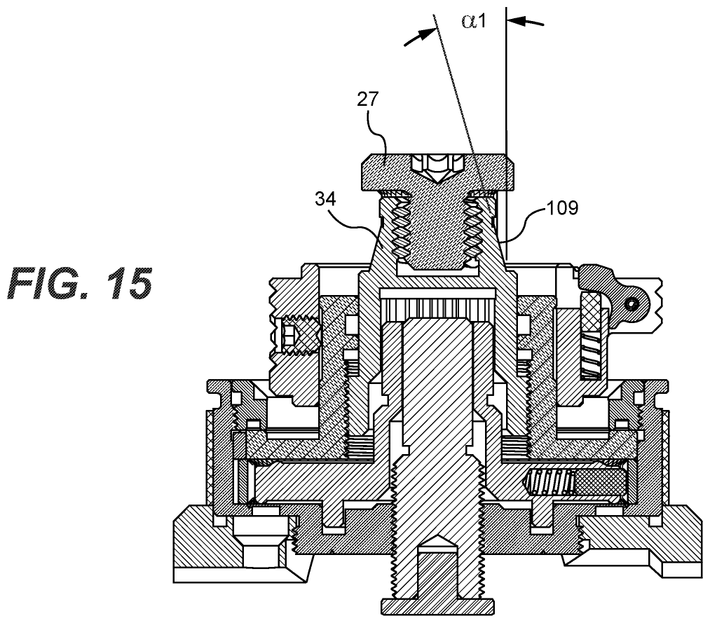

Suitably, the conical inner surface 111 forms an angle relative the rotational axis 5 that is the same or substantially similar as the angle of the conical outer surface 109 of the secondary jacking screw 34 allowing the male type conical outer surface 109 to mate with the female type conical inner surface 111 in a manner effective to maximize the contact surface between the conical inner surface 111 and the conical outer surface 109 as shown in FIGS. 2 and 3, which depict a conical outer surface 109 extended along the full length of the conical inner surface 111. In another embodiment, a conical outer surface 109 and/or a conical inner surface 111 may comprise one or more lengths other than as depicted in FIGS. 2-5. Although not limited to a particular tapered angle, in embodiments as shown in FIGS. 2-5 the male type conical outer surface 109 may have a tapered angle α1 from or about 5.0 degrees to or about 30.0 degrees. In an embodiment, the type conical outer surface 109 may have a tapered angle α1 of or about 15.0 degrees as shown in FIG. 15.

With particular reference to FIGS. 2 and 3, in an embodiment as shown a second end of the secondary jacking screw 34 may further include a female threaded surface 51 with one or more thread inserts 53 configured to receive a primary fastener 27 in a manner effective to secure a socket member 28 to the secondary jacking screw 34. In operation, when attaching a socket member 28 to a secondary jacking screw 34, once the conical inner surface 111 of the socket member 28 is mated with the conical outer surface 109 and the inner splined surface 108 is mated with the outer splined surface 110, the primary fastener 27 may be threaded into the female threaded surface 51 toward the secondary jacking screw 34 (see directional arrow C) wherein a force (see vector arrow V2) is applied to an annular outer contact surface 112 of the socket member 28 via the inner surface 114 of the head 113 of the primary fastener 27, which directs the socket member 28 toward the base member 36 (see directional arrow C) according to a slidable connection between the inner splined surface 108 of the socket member 28 and the outer splined surface 110 of the secondary jacking screw 34 to rotationally fix the conical inner surface 111 of the socket member 28 to the conical outer surface 109 of the secondary jacking screw 34. In addition, the splined connection between the inner splined surface 108 of the socket member 28 and the outer splined surface 110 of the secondary jacking screw 34 adds structural strength to the turret assembly 10 during operation of the turret assembly 10.

With particular reference to FIGS. 2, 3 and 14, the unlocking collar 22 may include an annular inner seat 116 configured to support one or more biasing members 26 biased between the seat 116 and an annular inner surface 117 of the retaining ring 24 that is removably attached to the socket member 28 for securing the one or more biasing members 26 between the retaining ring 24 and the inner seat 116. As shown, when the retaining ring 24 is operably attached to a socket member 28 the annular inner seat 116 is spaced apart from the inner surface 117 of the retaining ring 24 a distance forming, along with the socket member 28, an annular housing (or “biasing member housing”) effective for holding or retaining the one or more biasing members 26 therein.

Referring to FIG. 2, the splined inner surface 106 of the unlocking collar 22 and the splined outer surface 107 of the socket member 28 are configured as slidable contact surfaces wherein the unlocking collar 22 may be directed linearly along the rotational axis 5 in either direction (see directional arrow A) relative the socket member 28. As such, in an embodiment when a socket member 28 is operably mated in a fixed position with the second end of the secondary jacking screw 34 via a primary fastener 27 then a retaining ring 24 may be operably secured to a corresponding socket member 28 via a threaded connection between an outer threaded surface 118 of the socket member 28 and an inner threaded surface 119 of a retaining ring 24. When the retaining ring 24 is operably secured to the socket member 28 then the one or more biasing members 26 are configured to provide a biasing force (see vector arrow V3 in FIG. 3) to the unlocking collar 22 directing the unlocking collar 22 via the slidable connection between the splined inner surface 106 and the splined outer surface 107 to a resting locked position as shown in FIGS. 2, 3, 6 and 14, or, in the alternative, to a resting unlocked position where the locking lever 35 is not aligned with the locking slot 100 of the unlocking collar 22 as shown in FIG. 12. In an embodiment, the one or more biasing members 26 may include one or more wave springs, one or more flat wire coil springs, one or more disc springs, and combinations thereof.

Referring to FIGS. 2 and 3, in an embodiment an outer threaded surface 33 of a jacking screw 32 may include a first thread pitch and an outer threaded surface 59 of a secondary jacking screw 34 may include a second thread pitch wherein the second thread pitch of the secondary jacking screw 34 may be standardized across a plurality of optical sights and the first thread pitch of the jacking screw 32 may be unique to one or more of the plurality of optical sights. In addition, in an embodiment a jacking screw 32 and a secondary jacking screw 34 may include variation in thread starts, e.g., single-start threads, multi-start threads. In other words, in an embodiment a jacking screw 32 may move linearly in either direction along the rotational axis 5 when turned (hereafter referred to as an “up-and-down” direction) at one or more rates the same as or different than a secondary jacking screw 34. In one embodiment, metric thread sizes may be employed, i.e., according to the distance between crests of adjacent threads. In another embodiment, inch thread sizes may be employed, i.e., according to the number of threads per inch. For purpose of explanation, and not limitation, in an embodiment a secondary jacking screw 34 may include a second thread pitch of 1.0 mm wherein the secondary jacking screw 34 raises and lowers along the rotational axis 5 1.0 mm per single rotation of the unlocking collar 22. Depending on the configuration of a turret assembly 10, travel of a jacking screw 32 and travel of a secondary jacking screw 34 may end at the same moment during operation of a turret assembly 10. For example, in an embodiment where the jacking screw 32 has a first thread pitch of 2.0 mm, the secondary jacking screw 34 has a second thread pitch of 1.0 mm and the overall travel of the turret assembly 10 is 5.0 mm, the jacking screw 32 may rotate 2.5 rotations, meaning that the overall travel of the secondary jacking screw 34 is limited to 2.5 mm up-and-down along the rotational axis 5.

With reference to FIG. 3, in an embodiment a turret assembly 10 may include a contact member 39 (or “contact pad 39”) attached at a first end 16 of a jacking screw 32 for contacting a surface 202 of an adjustable member of an optical sight 8 such as an erector tube of an optical sight 8. As shown, a contact pad 39 may include a planar 41 type contact surface although other contact surface configurations are herein contemplated. As shown, a jacking screw 32 may include a first end 16 comprising a female surface 17 configured to receive a male part 18 of a contact pad 39 in a press fit configuration. In another embodiment, a turret assembly 10 may be provided without a contact pad 39 wherein a first end 16 of a jacking screw 32 may be used as a contact surface for contacting a contact surface 202 of an adjustable member of an optical sight 8.

To direct a turret assembly 10 from a locked position as depicted in FIGS. 2, 3, 6 and 14, a user may manually direct the unlocking collar 22 apart from the locking lever 35 linearly along rotational axis 5 (see directional arrow B) via the slidable connection between the splined inner surface 106 of the unlocking collar 22 and the splined outer surface 107 of the socket member 28 to clear the locking slot 100 of the unlocking collar 22 apart from the locking lever 35. Suitably, the unlocking collar 22 may be directed linearly apart from the locking lever 35 a maximum distance as determined by the size of the biasing member housing, the size of the one or more biasing members 26 and the spring stiffness of the one or more biasing members 26 located in the biasing member housing, which collectively establish a linear stop position for the unlocking collar 22 (and also establish a linear stop position for a turret cap 20 in an embodiment of a turret assembly 10 comprising a turret cap 20 as shown in FIGS. 4 and 5). As such, in an embodiment a biasing member housing and the one or more biasing members 26 housed therein may be collectively referred to as a “biasing assembly,” a “manual adjustment member biasing assembly” and an “unlocking collar biasing assembly” of a turret assembly 10. Once the locking slot 100 is clear of the locking lever 35, a user may manually turn the unlocking collar 22 counterclockwise through a desired angle of rotation wherein the head section 69 of the locking lever 35 abuts the inner surface annular contact surface 105 of the unlocking collar 22 as shown in FIG. 12. In an embodiment, the contact surface 105 of the unlocking collar 22 may include a smooth planar surface and the biasing force of the one or more biasing members 26 may be greater than the biasing force of the one or more biasing members 75 thereby promoting a sliding action of the head section 69 of the locking lever 35 against the contact surface 105 when the turret assembly 10 is turned clockwise and counterclockwise.

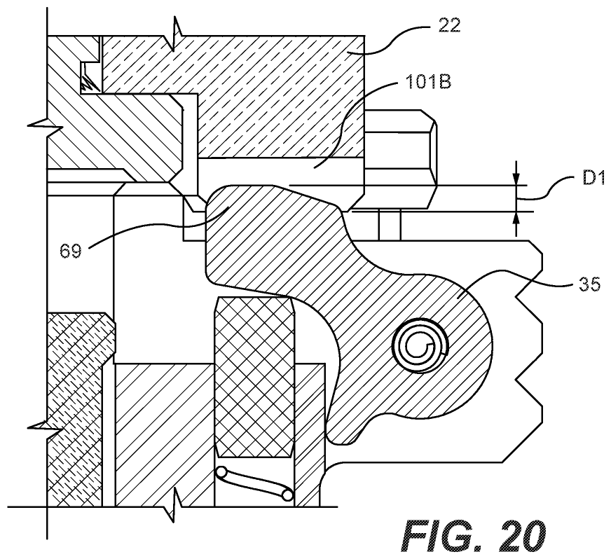

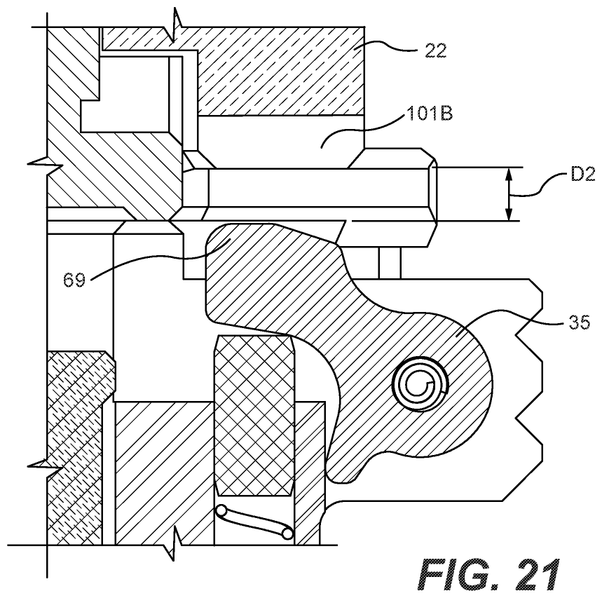

Although a turret assembly 10 of this disclosure may be built to scale, in an embodiment of a turret assembly 10 configured for use with an optical sight 8 for a firearm, when the turret assembly 10 is set to a locked position the locking lever 35 may be located at a depth within the locking slot 100 from or about 0.5 mm to or about 0.9 mm. In another embodiment, a locking lever 35 may be located at a depth within the locking slot 100 of or about 0.7 mm, i.e., a mating distance of or about 0.7 mm between the head section 69 of the locking lever 35 and the locking slot 100 (see mating distance D1 in FIG. 20). Suitably, the configuration of an unlocking collar biasing assembly as described above is effective to provide a linear travel distance of the unlocking collar 22 greater than the mating distance D1 allowing the locking slot 100 of the unlocking collar 22 to clear the head section 69 of the locking lever 35 (see FIG. 21) when the unlocking collar 22 is directed away from the locking lever 35 (see directional arrow B in FIG. 3). In an embodiment, the configuration of an unlocking collar biasing assembly is effective to provide a linear travel distance of an unlocking collar 22 providing a clearance distance D2 of the locking slot 100 from the locking lever 35 as desired. In an embodiment, a clearance distance D2 may range from or about 0.1 mm to or about 0.4 mm. In an embodiment of a turret assembly 10 including a mating distance D1 of or about 0.7 mm, the configuration of an unlocking collar biasing assembly may be effective to provide a maximum linear travel distance of the unlocking collar 22 from or about 0.8 mm to or about 1.1 mm providing a clearance distance D2 of the locking slot 100 from the locking lever 35 from or about 0.1 mm to or about 0.4 mm. In an embodiment, a maximum linear travel distance of the unlocking collar 22 may include a distance of or about 1.05 mm.

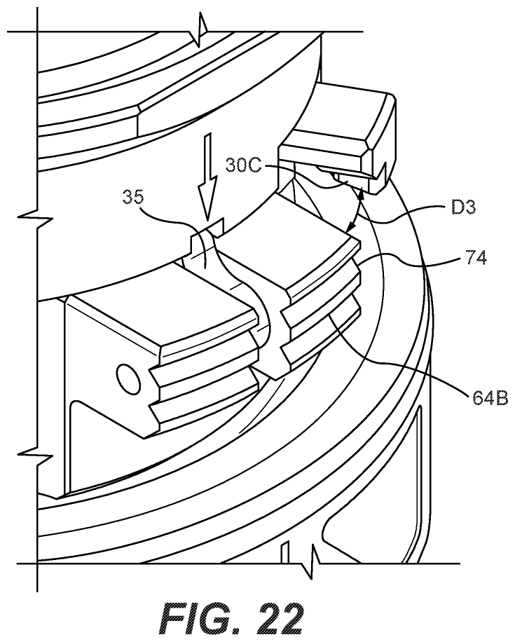

When a turret assembly 10 is turned to an unlocked position as depicted in FIG. 12, the communication between the click ring 88 and the click detent 89 may assist in maintaining a fixed unlocked position of the unlocking collar 22. To return a turret assembly 10 from an unlocked position back to a locked position as shown in FIGS. 2, 3, 6 and 14, the unlocking collar 22 may be turned clockwise until the locking lever 35 engages the locking slot 100 under the biasing force of the one or more biasing members 26 (see vector arrow V3 in FIG. 3). In a scenario where an unlocking collar 22 is turned beyond a locked position of the locking lever 35 within the locking slot 100, the socket member 28 is configured to prevent clockwise turning of the unlocking collar 22 beyond a predetermined angle of rotation, e.g., a predetermined number of clicks beyond a zero position of the turret assembly 10. Referring to FIG. 13, in an embodiment a socket member 28 may include a projection member 30B extending out radially from a ring portion 30A of the socket member 28 wherein the projection member 30B is keyed with an over travel stop slot 103 of an unlocking collar 22 during operation with at least part of the projection member 30B (or “over travel stop member 30B) disposed within the over travel stop slot 103 when the unlocking collar 22 is turned clockwise and counterclockwise. As shown in FIG. 13, the over travel stop member 30B further includes a stop surface 30C extending out from the over travel stop member 30B toward the base member 36 a distance effective to contact a near side surface 74 (or “contact side 74”) of the projection member 64B in instances where the unlocking collar 22 is turned beyond a locked position of the turret assembly 10, i.e., turned beyond a zero locked position of the turret assembly 10. As shown in FIG. 22, when the turret assembly 10 is set to a locked position the stop surface 30C is spaced apart from the contact side 74 of the projection member 64B a desired angular distance D3 corresponding to an angular distance between the locking slot 100 and the over travel stop slot 103 of the unlocking collar 22 and also correlating to a predetermined number of clicks of the unlocking collar 22 beyond zero. In an embodiment, a stop surface 30C of a socket member 28 may be configured to contact a contact side 74 of a projection member 64B any number of clicks beyond a zero position of the turret assembly 10 as desired, e.g., two (2.0) clicks to five (5.0) clicks. In an embodiment, a stop surface 30C of a socket member 28 may be configured to contact a contact side 74 of a projection member 64B three (3.0) clicks beyond a zero position of the turret assembly 10. In an embodiment, a stop surface 30C of a socket member 28 may be configured to contact a contact side 74 of a projection member 64B four (4.0) clicks beyond a zero position of the turret assembly 10.

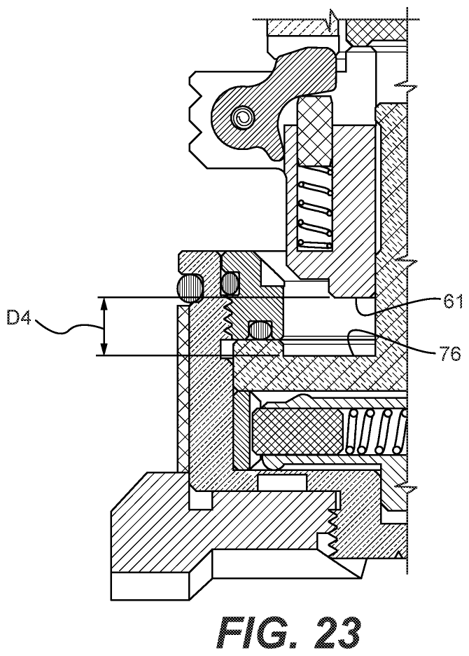

An advantageous feature of a turret assembly 10 of this disclosure includes the ability to (1) turn the locking lever carrier member 60 about the rotational axis 5 up to 360.0 degrees or more and (2) position the locking lever carrier member 60 linearly along the rotational axis 5 at one or more points when establishing a zero locked position of the locking lever carrier member 60 for use with a corresponding unlocking collar 22. In other words, a locking lever carrier member 60 of this disclosure is not rotationally or linearly constrained to any one position or orientation. As shown in the embodiment of FIGS. 2, 3 and 14, when a turret assembly 10 is set to a locked position, the configuration of the locking lever carrier member 60, the secondary jacking screw support member 50, and the lock ring 52 collectively provide an open space defining a distance D4 (see FIG. 23) from a proximal end 61 of the locking lever carrier member 60 to an annular floor 76 of the ring portion 56 of the secondary jacking screw support member 50. Suitably, the distance D4 defines the linear travel distance of the locking lever carrier member 60 along the rotational axis 5 during operation of the turret assembly 10.

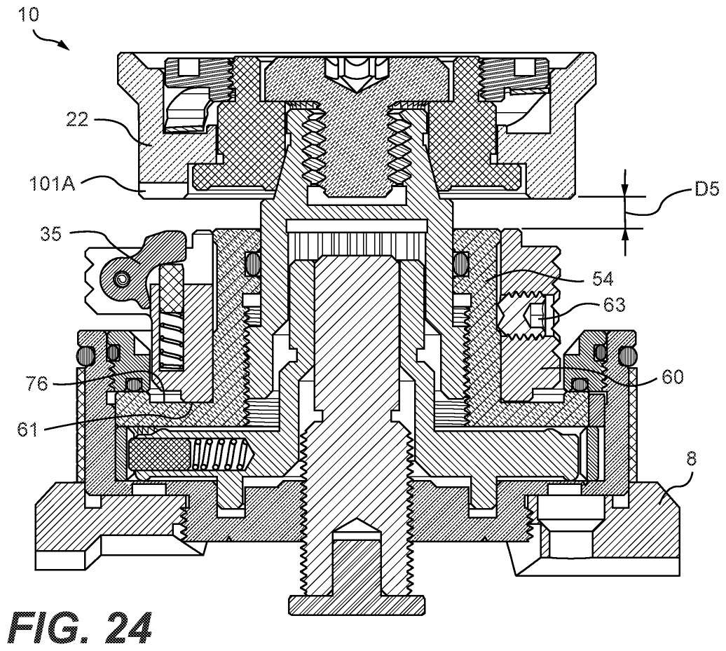

To establish a zero locked position of a turret assembly 10, a user may remove or otherwise loosen the one or more threaded fasteners 63 allowing the locking lever carrier member 60 to be directed linearly apart from the unlocking collar 22 (see directional arrow C in FIG. 3) to at least a first non-contact position so that the unlocking collar 22 may be freely turned counterclockwise to establish a zero position for the turret assembly 10. As understood by the skilled artisan, a zero position of a turret assembly 10 of a firearm optical sight 8 is a position at which a point of aim of a reticle of the optical sight 8 matches a projectile point of impact at a certain distance from the reticle. At a maximum non-contact position as shown in FIG. 24, the proximal end 61 of the locking lever carrier member 60 is set at an abutment position against the annular floor 76 according to the open space defining distance D4. Once the locking lever carrier member 60 is moved to a non-contact position such as shown in FIG. 24, the locking lever carrier member 60 may be fixed to the cylindrical portion 54 of the secondary jacking screw support member 50 via the one or more threaded fasteners 63 at a point nearer the annular floor 76 than when the locking lever 35 is set to a locked position with the locking slot 100. By setting a locking lever carrier member 60 to a non-contact position a distance apart from the unlocking collar 22, for example, a distance D5 as shown in FIG. 24, a user may freely manually turn the unlocking collar 22 to establish a zero position for the turret assembly 10. In firearm applications, a user may manually turn an unlocking collar 22 until a zero position of the turret assembly 10 is established whereby the unlocking collar 22 is set at a desired orientation about the rotational axis 5. Once turret assembly 10 is set to a zero position, the locking lever carrier member 60 may be directed to a locked position with the unlocking collar 22 by turning the locking lever carrier member 60 as needed to mate the locking lever 35 with the locking slot 100 of the unlocking collar 22 and by securing the locking lever carrier member 60 to the cylindrical portion 54 of the secondary jacking screw support member 50 via the one or more threaded fasteners 63. In another embodiment, a turret assembly 10 may include one or more actuable detent members in place of or in addition to the one or more threaded fasteners 63 for fixing the locking lever carrier member 60 to the cylindrical portion 54 of the secondary jacking screw support member 50. Also, in an embodiment of a turret assembly 10 comprising a turret cap 20 as shown in FIGS. 4 and 5, the one or more turret cap set screws 29 may be removed or otherwise loosened to remove the turret cap 20 from the unlocking collar 22 in order to manipulate the unlocking collar 22 to establish a zero locked position of the turret assembly 10 as described above. Once a zero locked position of the turret assembly 10 is realized, the turret cap 20 may be reattached to the unlocking collar 22 via the one or more turret cap set screws 29.

Referring to FIGS. 2 and 3, a turret assembly 10 may include one or more seals configured to prevent moisture and/or dirt from entering the turret assembly 10. Suitable seals may include, but are not limited to one or more O-rings, e.g., one or more nitrile butadiene rubber O-rings (Buna-N O-rings), or the like. For example, a turret assembly 10 may include an O-ring 125 providing a seal between the secondary jacking screw 34 and the cylindrical portion 54 of the secondary jacking screw support member 50 and/or an O-ring 126 providing a seal between the lock ring 52 and the pocket member 37 of the base member 36 and/or an O-ring 127 providing a seal between the lock ring 52 and the ring portion 56 of the secondary jacking screw support member 50. In an embodiment of a turret assembly 10 including a turret cap 20, a turret assembly 10 may also include an O-ring 128 providing a seal between the pocket member 37 of the base member 36 and the turret cap 20.

With reference to FIGS. 2, 5, and 6, a turret assembly 10 of this disclosure may include one or more position indicators 13 disposed along the outer surface of the base member 36 as shown. In an embodiment, the one or more position indicators 13 may be provided as a permanent member of a turret assembly 10, e.g., adhered and/or fastened to the main seat member 36. In an embodiment, the one or more position indicators 13 may be removably attachable to the turret assembly 10, e.g., configured as a slip-on type member around the main seat member 36. As such, a turret assembly 10 of this disclosure may include a plurality of interchangeable position indicators 13. With reference to FIGS. 6 and 10, a turret assembly 10 of this disclosure may include one or more zero stop alignment indicators 85 disposed along the unlocking collar 22 aligned with a center point 100A of the locking slot 100 as shown.

As appreciated by the skilled artisan, the components of a turret assembly 10 may be provided in one or more colors as desired including, but not limited to colors and color patterns common in the field of firearm optical sights. e.g., black, silver, army green or olive drab (“OD”) green, a color often referred to in the art of optical sights as “flat dark earth,” one of a plurality of camouflage patterns, and combinations thereof. In a non-limiting example, an unlocking collar 22 and/or a turret cap 20 may include the color black and may include non-black color rotational position markings and/or alignment indicators as known in the art of turret caps. In a non-limiting example, an unlocking collar 22 may include the color black and the one or more zero stop alignment indicators 85 may include the color white, or one or more other colors of a shade(s) lighter than the color black.

A turret assembly comprising an unlocking collar assembly as described above may also be included as part of a windage turret assembly of an optical sight. However, where a turret assembly 10 described above comprises a zero locked position with an over travel stop member 30B, a windage turret assembly described herein does not include an over travel stop member because, unlike elevation adjustments, windage adjustments are necessarily made cither direction, i.e., made either side, of a locked position of the windage turret assembly. Also, because a windage turret assembly does not necessarily require the one or more position indicators 13 as described above, a windage turret assembly, which is typically mounted to a side of an optical sight, may be configured in a more compact package, i.e., configured shorter than a turret assembly 10 described above.

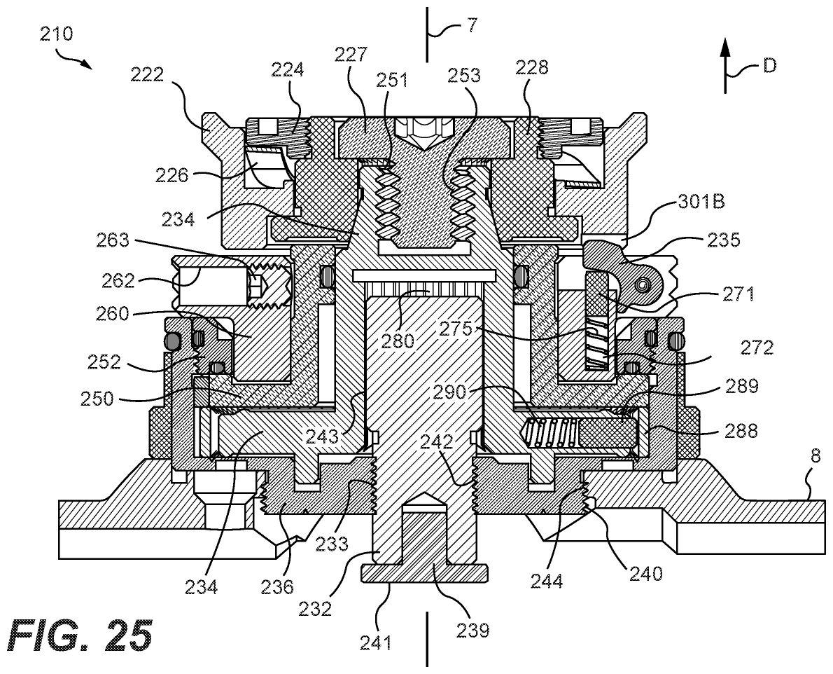

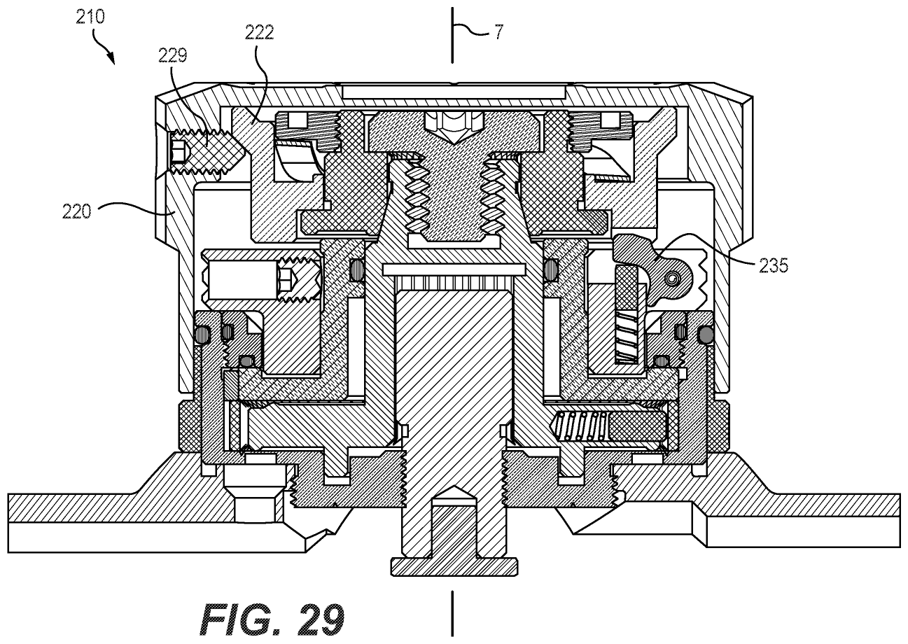

Referring to FIGS. 25-28, in an embodiment a windage turret assembly 210 (hereafter “turret assembly 210”) comprises an adjustable assembly including at least an unlocking member 222 (or “unlocking collar 222”), a retaining ring 224, one or more biasing members 226, an annular socket member 228, a primary threaded fastener 227 (or “primary fastener 227”), a first adjustment member 232 (or “jacking screw 232”), and an annular main shaft member 234 (or “main shaft 234”). A turret assembly 210 of this embodiment also comprises a nonadjustable assembly including at least an annular main seat member 236, a secondary jacking screw support member 250, a lock ring 252, and a locking lever carrier member 260. As shown in FIG. 29, and as similar as described above, in an embodiment an adjustable assembly of a turret assembly 210 may further include a turret cap 220 removably attachable to the unlocking collar 222 via one or more turret cap set screws 229. In operation, each member of an adjustable assembly of a turret assembly 210 is configured to rotate about a rotational axis 7 of the turret assembly 210 clockwise and counterclockwise when the turret assembly 210 is manipulated in either direction. In an embodiment of a turret assembly 210 comprising a turret cap 220 as shown in FIG. 29, an unlocking collar 222 may also be referred to as a “turret cap seat 222” and a socket member 228 may also be referred to as a “turret cap hub 228.”

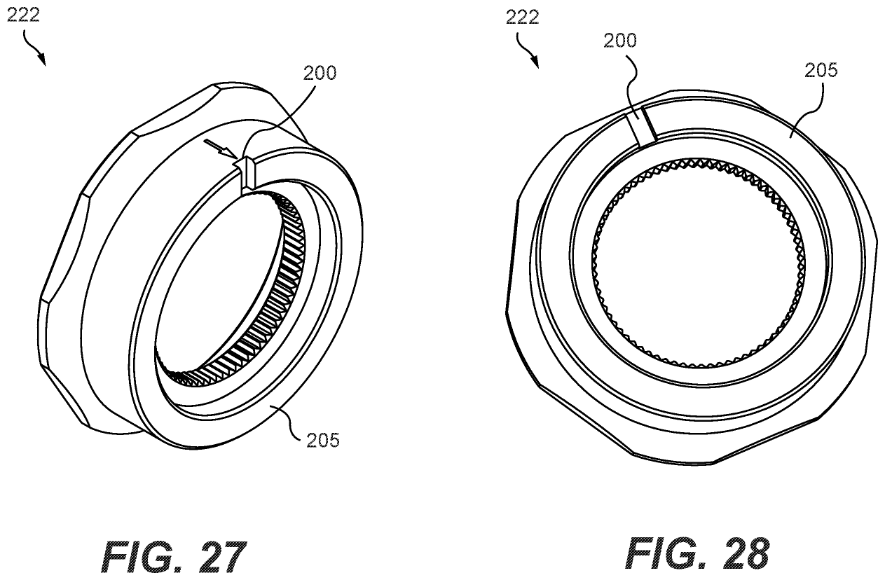

Similar as a turret assembly 10, an adjustable assembly of a turret assembly 210 includes an unlocking collar assembly comprising an unlocking collar 222, a retaining ring 224, one or more biasing members 226, a socket member 228, and a primary fastener 227. Unlike a turret assembly 10, a socket member 228 of a turret assembly 210 does not include an over travel stop member similar as an over travel stop member 30B described above. As such, an unlocking collar 222 of a turret assembly 210 does not include or require an over travel stop slot similar as an over travel stop slot 103 of an unlocking collar 22—see the annular contact surface 205 of unlocking collar 222 in FIGS. 27 and 28, which comprises only a locking slot 200 and no over travel stop slot. As described below, an adjustable assembly of a turret assembly 210 also does not include a main shaft like main shaft 77 of a turret assembly 10 described above thereby reducing the overall height of the turret assembly 210 that extends out from a corresponding optical sight 8 compared to the height of a turret assembly 10 as extended out from a corresponding optical sight 8.

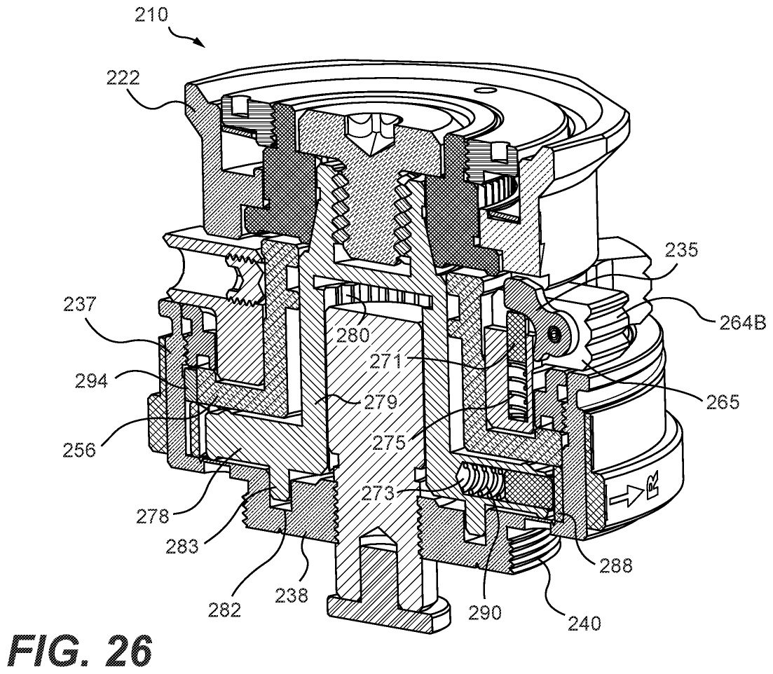

With reference to FIGS. 25 and 26, in an embodiment a base member 236 includes a pocket member 237 and a spigot portion 238 (or “spigot 238”). The spigot 238 may include an outer threaded surface 240 for threaded communication with an inner threaded surface 244 of an optical sight 8 wherein a turret assembly 210 may be operably threaded to an optical sight 8 wherein a central axis of the base member 236 defines the rotational axis 7 of the turret assembly 210. In this embodiment, the main shaft 234 includes a ring portion 278 and a cylindrical portion 279 similar in operation as a ring portion 78 and a cylindrical portion 79 of a main shaft 77. In particular, a ring portion 278 includes an annular protruding member 283 configured to mate with an annular channel 282 of the spigot 238 of the base member 236 in a manner effective for the protruding member 283 of the main shaft 234 to turn freely within the annular channel 282 during operation of the turret assembly 210, wherein the annular channel 282 is configured to maintain a proper axial alignment of the main shaft 234 during turret assembly 210 operation.

Still referring to FIGS. 25 and 26, a turret assembly 210 also includes a secondary jacking screw support member 250 and a lock ring 252 similar as a secondary jacking screw support member 50 and lock ring 52 described above. As shown, a ring portion 256 of the secondary jacking screw support member 250 is disposed parallel and adjacent the ring portion 278 of the main shaft 234 wherein the ring portion 256 of the secondary jacking screw support member 250 is fixed to the pocket member 237 of the base member 236 via at least one locating pin 294 disposed between the pocket member 237 of the base member 236 and the ring portion 256 of the secondary jacking screw support member 250 in a manner similar as described above in reference to FIGS. 2, 3 and 16.

A turret assembly 210 of this embodiment further includes a click ring 288 and a corresponding click detent 289 located in a radial borehole 273 of the ring portion 278 of the main shaft 234 along with at least one biasing member 290 configured to bias the click detent 289 radially outward to an abutment position with the click ring 288 in a manner similar as described above in reference to click ring 88, click detent 89 and the at least one biasing member 90 of turret assembly 10. The turret assembly 210 also includes a locking lever carrier member 260 similar as a locking lever carrier member 60 of turret assembly 10, the locking lever carrier member 260 comprising a projection with opposing projection members (see projection member 264B) defining an open slot 265 for holding a pivotally attached locking lever 235 radially disposed within the slot 265 similar as described above. As shown, a locking lever carrier member 260 also includes a biased pin member 271 (or “locking lever plunger 271”) housed within a cavity 272 of the locking lever carrier member 260 in addition to one or more biasing members 275, e.g., one or more coiled springs, wherein the one or more biasing members 275 are configured to bias the pin member 271 in a manner effective for the locking lever 235 to be directed to a mating position with a locking slot 200 of an unlocking collar 222 as shown in FIGS. 25, 26 and 29 (see locking slot 200 in FIGS. 27 and 28; see also sidewall 301B of locking slot 200 in FIG. 25). The locking lever carrier member 260 also includes one or more radial threaded boreholes 262 for receiving one or more threaded fasteners 263, e.g., one or more threaded set screws, there through in a manner effective to fixedly secure the locking lever carrier member 260 to the secondary jacking screw support member 250 during operation of the turret assembly 210. In an embodiment, the locking lever carrier member 260, including the projection comprising opposing projection members (see projection member 264B), the locking lever 235, the cavity 272, the pin member 271, and the one or more biasing members 275 may be collectively referred to herein as a “locking lever assembly” of the turret assembly 210.

With further reference to the embodiment of FIGS. 25 and 26, the main shaft 234 includes a splined inner surface 280 in communication with a splined outer surface 243 of the jacking screw 232 in a one-to-one rotational relationship. The jacking screw 232 also includes an outer threaded surface 233 of a thread pitch for threaded communication with a corresponding inner threaded surface 242 of a main seat member 236. As shown, a jacking screw 232 may also include a contact member 239 (or “contact pad 239”) mated thereto, the contact pad 239 having a smooth or otherwise clean planar face 241 type contact surface configured to contact a surface 202 of an adjustable member of an optical sight 8 similar as described above.

Similar as a turret assembly 10 described above, the second end of the main shaft 234 may include a female threaded surface 251 including one or more thread inserts 253 configured to receive a primary fastener 227 in a manner effective to secure a socket member 228 to the main shaft 234.

Referring to an embodiment of a turret assembly 210 as shown in FIG. 25, a user may establish a zero locked position for the turret assembly 210 similar as described above. In operation, a user may also manually direct the unlocking collar 222 apart from the locking lever 235 to clear the locking slot 200 from the locking lever 235 (see directional arrow D). Once the turret assembly 210 is in an unlocked position, a user may turn the unlocking collar 222 clockwise or counterclockwise as desired with the locking lever 235 biased against the contact surface 205 of the unlocking collar 222 to adjust a reticle of the corresponding optical sight 8 to one or more unlocked positions of the turret assembly 210 for purposes of making windage adjustments of the optical sight 8. Thereafter, a user may manually return the turret assembly 210 to a locked position wherein the locking lever 235 is mated with the locking slot 200.

Referring to an embodiment of a turret assembly 210 as shown in FIG. 29 including a turret cap 220 removably attached to an unlocking collar 222, in operation a user may manually direct the turret assembly 210 to one or more unlocked positions and return the turret assembly 210 back to a locked position similar as described in the preceding paragraph by manually manipulating the turret cap 220, which is rotatably coupled to the unlocking collar 222.

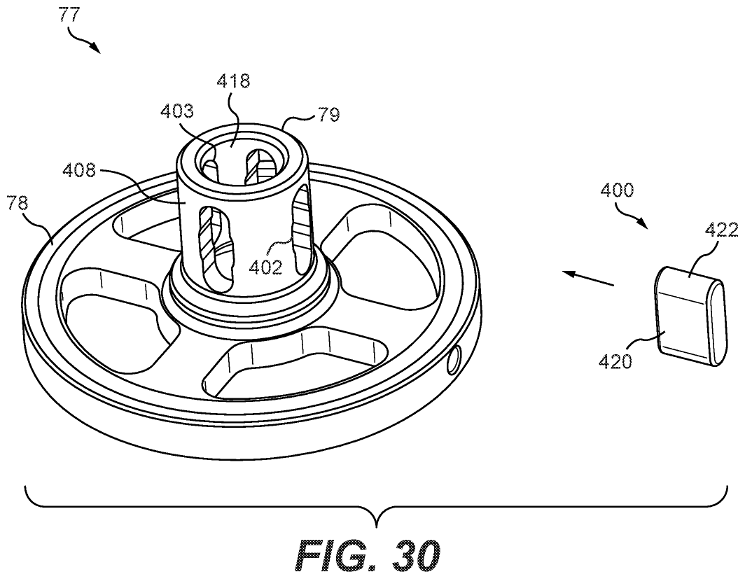

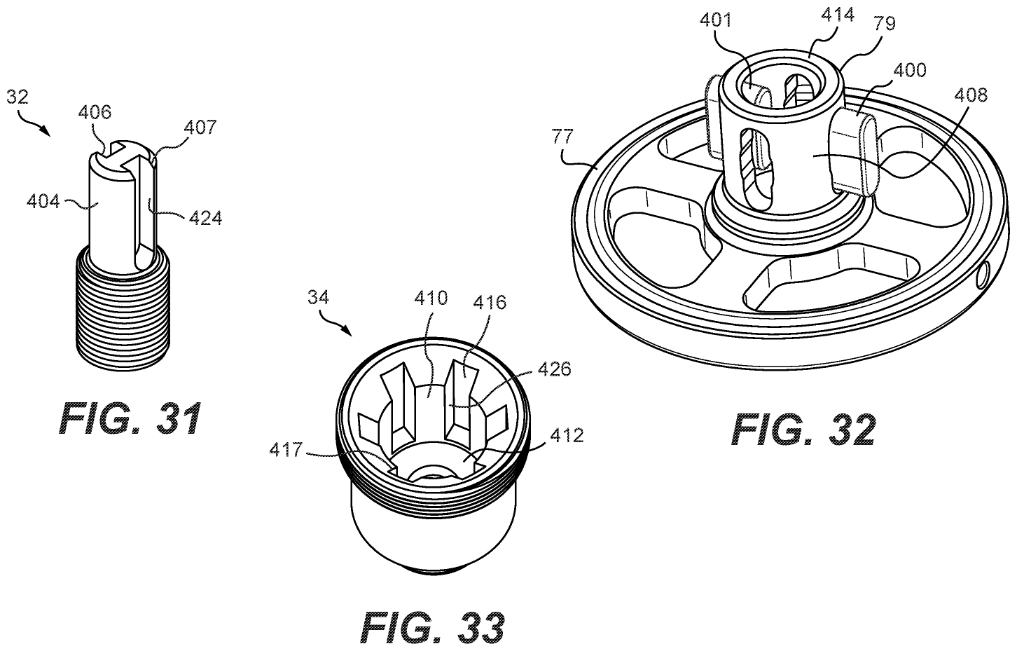

With reference to FIGS. 30-33, in another embodiment a jacking screw 32 and a secondary jacking screw 34 of a turret assembly 10 may be coupled or keyed together via one or more key members (see key members 400 and 401) inserted through the raised cylindrical portion 79 of the main shaft 77 providing a key joint assembly having a one-to-one rotational relationship. In particular, the cylindrical portion 79 includes one or more apertures or “keyseats” configured to receive a corresponding key member in a manner effective to couple the jacking screw 32 with the secondary jacking screw 34 (see key members 400 and 401 mated with keyseats 402 and 403 in FIG. 32). As shown in FIG. 31, one suitable jacking screw 32 includes a non-threaded section 404 with two opposing slots 406 and 407 (or “keyways 406 and 407”) disposed lengthwise along the non-threaded section 404 for receiving key members 400 and 401 therein. In particular, when the jacking screw 32 is set to a mated position within the main shaft 77, the keyways 406 and 407 are aligned with two opposing keyseats 402 and 403 enabling key members 400 and 401 to be press fit through the keyseats 402 and 403 into the keyways 406 and 407 for rotatably fixing the jacking screw 32 to the main shaft 77. With reference to FIG. 32, when the key members 400 and 401 are set in the keyseats 402 and 403, an inner portion of the key members 400 and 401 extend radially inward a distance effective to engage the corresponding keyways 406 and 407. As shown, an outer portion of the key members 400 and 401 extend outward from an outer surface 408 of the cylindrical portion 79 for mating with the secondary jacking screw 34.

With reference to FIG. 33, in an embodiment the secondary jacking screw 34 may include an opening along the rotational axis 5 defined by an inner surface 410 for receiving the cylindrical portion 79 of the main shaft 77 therein. As shown, the inner surface 410 includes an annular abutment surface 412 for receiving a distal end 414 of the cylindrical portion 79. The inner surface 410 further includes at least key slots 416 and 417 for receiving the outer portion of the key members 400 and 401 therein. As shown, a secondary jacking screw 34 of this embodiment has a total of six key slots disposed equally apart about the inner surface 410, i.e., four key slots in addition to key slots 416 and 417. However, in another embodiment the secondary jacking screw 34 may include a minimum number of key slots effective for mating with a particular total number of key members included as part of the turret assembly 10. Suitably, the inner diameter of the inner surface 410 of the secondary jacking screw 34 is substantially similar as the outer diameter of the outer surface 408 of the cylindrical portion 79 of the main shaft 77 and the outer diameter of the non-threaded section 404 of the jacking screw 32 is substantially similar as the inner diameter of the inner surface 418 of the cylindrical portion 79 of the main shaft 77 providing a machine fit there between.

With reference to key member 400 in FIG. 30, in an embodiment the key members 400 and 401 may include a perimeter mating surface(s) for mating with corresponding keyseats 402 and 403, keyways 406 and 407, and key slots 416 and 417. As shown in FIG. 30, in an embodiment a key member 400 may include opposing planar engagement surfaces (see planar engagement surface 420) and opposing curved engagement surfaces (see first curved engagement surface 422) for mating with planar surfaces of keyways 406 and 407 (see planar surface 424 of keyway 407 in FIG. 31) and planar surfaces of key slots 416 and 417 (see planar surface 426 of key slot 416 in FIG. 33). In another embodiment, the size and/or shape of the key members 400 and 401, keyseats 402 and 403, and keyways 406 and 407 may vary.

A turret assembly 10 and a turret assembly 210 of this disclosure may be constructed of one or more materials durable for one or more operations and/or as may be required by law or regulation. Suitable materials of construction may include, but are not necessarily limited to those materials resistant to chipping, cracking, excessive bending and reshaping as a result of ozone, weathering, heat, moisture, other outside mechanical and chemical influences, as well as physical impacts. In particular, a turret assembly 10 or turret assembly 210 of this disclosure may be constructed of materials including, but not necessarily limited to metals, plastics, rubbers, woods, filled composite materials, and combinations thereof. Suitable metals may include, but are not necessarily limited to stainless steel, hardened steel, mild steel, aluminum, copper, nickel alloys, copper-nickel alloys, brass alloys, aluminum alloys, titanium alloys, and combinations thereof. Suitable plastics include, but are not necessarily limited to glass-filled polymers, durable plastic composite materials, and combinations thereof. One suitable glass-filled polymer includes, but is not necessarily limited to glass-filled nylon. In an embodiment, one or more components of turret assemblies 10 and 210 made be constructed of one or more low-friction materials.

The disclosure will be better understood with reference to the following non-limiting examples, which are illustrative only and not intended to limit the present disclosure to a particular embodiment.

### Example 1

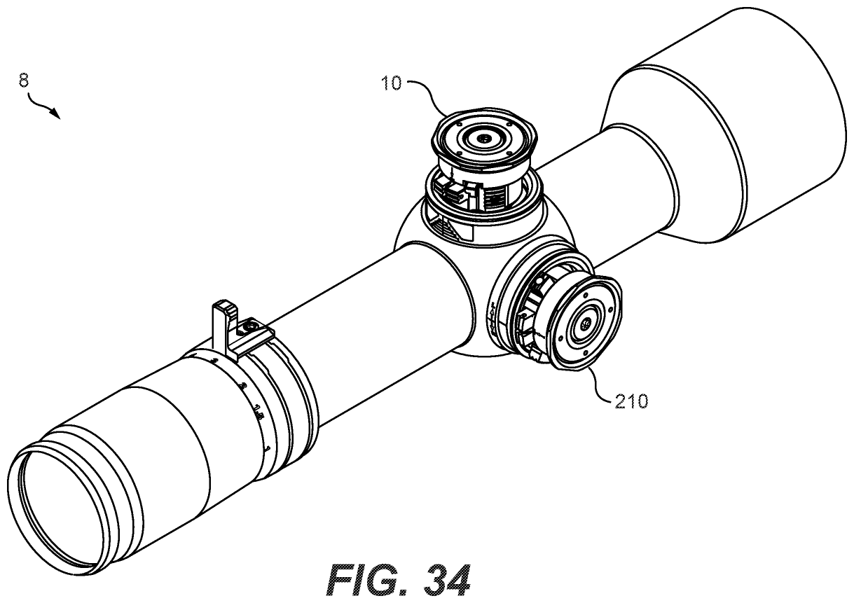

In a first non-limiting example, an embodiment of an optical sight 8 as shown in FIG. 34 is provided comprising an elevation turret assembly 10 as shown in FIGS. 1-3 and comprising a windage turret assembly 210 as shown in FIG. 25.

### Example 2

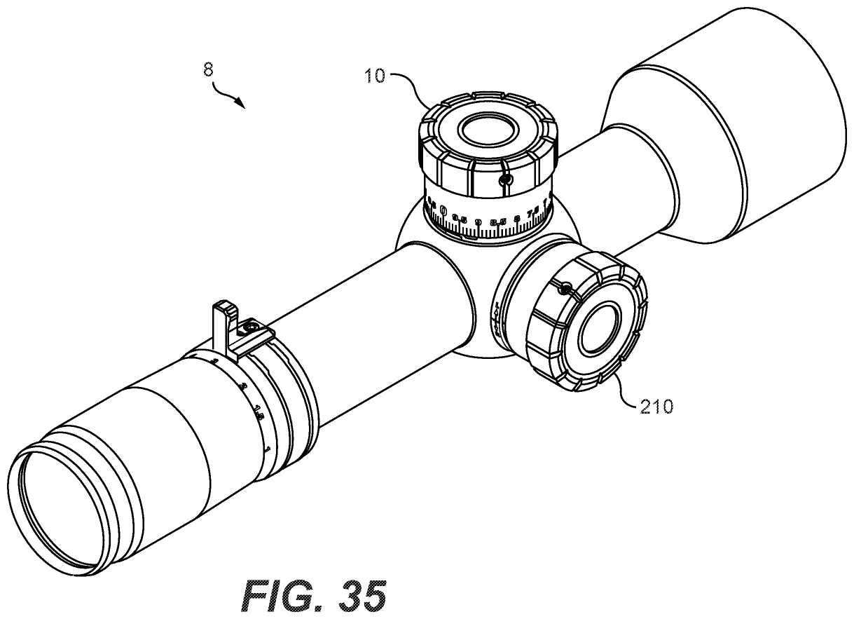

In a second non-limiting example, an embodiment of an optical sight 8 as shown in FIG. 35 is provided comprising an elevation turret assembly 10 as shown in FIGS. 4 and 5 and a windage turret assembly 210 as shown in FIG. 29.

The present disclosure may be described according to one or more of the following Embodiments.

Embodiment 1. A turret assembly for an optical sight, comprising:
a locking member; and
a locking surface for the locking member;
wherein the locking member is biased toward the locking surface;
wherein the locking surface is biased toward the locking member;
wherein the locking surface is adjustable about a rotational axis of the turret assembly and adjustable along the rotational axis of the turret assembly; and
wherein the locking member is adjustable about the rotational axis of the turret assembly and adjustable along the rotational axis of the turret assembly.

Embodiment 2. The turret assembly of Embodiment 1, wherein the locking member includes a pivotal locking lever biased toward the locking surface.

Embodiment 3. The turret assembly of Embodiment 1, wherein the locking surface includes a first radially disposed slot of an unlocking member configured to receive at least part of the locking member therein.

Embodiment 4. The turret assembly of Embodiment 3, wherein the unlocking member is configured to be set to one or more locked positions with the locking member and configured to be set to one or more unlocked positions with the locking member.

Embodiment 5. The turret assembly of Embodiment 4, wherein the unlocking member is configured as a manual adjustment member of the turret assembly.

Embodiment 6. The turret assembly of Embodiment 5, wherein the unlocking member is configured as an attachment surface for a removable cap member.

Embodiment 7. The turret assembly of Embodiment 3, further comprising an over travel stop member turnable about the rotational axis of the turret assembly, wherein the unlocking member includes at least a second radially disposed slot configured to receive at least part of the over travel stop member therein.

Embodiment 8. The turret assembly of Embodiment 6, further comprising a housing for the pivotal locking lever, wherein the housing includes a contact surface for the over travel stop member.

Embodiment 9. The turret assembly of Embodiment 4, wherein the one or more locked positions include one or more zero positions of the turret assembly.

Embodiment 10. The turret assembly of Embodiment 3, wherein the unlocking member is configured to be set to a plurality of locked positions with the locking member and configured to be set to a plurality of unlocked positions with the locking member.

Embodiment 11. The turret assembly of Embodiment 10, wherein the plurality of locked positions include a plurality of zero positions of the turret assembly.

Embodiment 12. A turret assembly for an optical sight, comprising:
a pivotal locking lever; and
an unlocking member comprising a locking surface for the pivotal locking lever;
wherein the pivotal locking lever is biased toward the unlocking member;
wherein the unlocking member is biased toward the pivotal locking lever;
wherein the unlocking member is adjustable about a rotational axis of the turret assembly and adjustable along the rotational axis of the turret assembly; and
wherein the pivotal locking lever is adjustable about the rotational axis of the turret assembly and adjustable along the rotational axis of the turret assembly.

Embodiment 13. The turret assembly of Embodiment 12, wherein the unlocking member includes a locking slot for receiving at least part of the pivotal locking lever therein.

Embodiment 14. The turret assembly of Embodiment 13, wherein the unlocking member is configured to be set to one or more locked positions with the pivotal locking lever and configured to be set to one or more unlocked positions with the pivotal locking lever.

Embodiment 15. The turret assembly of Embodiment 14, wherein the unlocking member is configured as a manual adjustment member of the turret assembly.

Embodiment 16. The turret assembly of Embodiment 15, wherein the unlocking member is configured as an attachment surface for a removable cap member.

Embodiment 17. A turret assembly for an optical sight, comprising:
a locking system including:
an unlocking collar assembly; and
a locking lever assembly;
wherein the locking lever assembly comprises a pivotal locking lever biased toward the unlocking collar assembly;
wherein the unlocking collar assembly comprises an unlocking collar biased toward the locking lever assembly; and
wherein the unlocking collar assembly may be set to one or more locked positions with the locking lever assembly and set to one or more unlocked positions with the locking lever assembly.

Embodiment 18. The turret assembly of Embodiment 17, wherein the one or more locked positions include one or more zero positions of the turret assembly.

Embodiment 19. The turret assembly of Embodiment 18, wherein the unlocking collar is configured as an attachment surface for a removable cap member.

Embodiment 20. A method, comprising:
establishing a zero position of a firearm optical sight via a turret assembly operably secured to the firearm optical sight, the turret assembly including:
a locking member; and
a locking surface for the locking member;
wherein the locking member is biased toward the locking surface;
wherein the locking surface is biased toward the locking member;
wherein the locking surface is adjustable about a rotational axis of the turret assembly and adjustable along the rotational axis of the turret assembly; and
wherein the locking member is adjustable about the rotational axis of the turret assembly and adjustable along the rotational axis of the turret assembly.

Embodiment 21. A method, comprising:
establishing a zero position of a firearm optical sight via a turret assembly operably secured to the firearm optical sight, the turret assembly including:
a pivotal locking lever; and
an unlocking member comprising a locking surface for the pivotal locking lever; wherein the pivotal locking lever is biased toward the unlocking member;
wherein the unlocking member is biased toward the pivotal locking lever;
wherein the unlocking member is adjustable about a rotational axis of the turret assembly and adjustable along the rotational axis of the turret assembly; and wherein the pivotal locking lever is adjustable about the rotational axis of the turret assembly and adjustable along the rotational axis of the turret assembly.

Embodiment 22. A method, comprising: establishing a zero position of a firearm optical sight via a turret assembly operably secured to the firearm optical sight, the turret assembly including:
a locking system including:
an unlocking collar assembly; and
a locking lever assembly;
wherein the locking lever assembly comprises a pivotal locking lever biased toward the unlocking collar assembly;
wherein the unlocking collar assembly comprises an unlocking collar biased toward the locking lever assembly; and
wherein the unlocking collar assembly may be set to one or more locked positions with the locking lever assembly and set to one or more unlocked positions with the locking lever assembly.

Embodiment 23. A turret assembly for an optical sight, comprising:
a pivotal locking lever; and
a locking surface for the pivotal locking lever;
wherein the pivotal locking lever is biased toward the locking surface;
wherein the locking surface is biased toward the pivotal locking lever;
wherein the locking surface may be set to a plurality of locked positions with the pivotal locking lever about a rotational axis of the turret assembly and wherein the locking surface may be set to a plurality of unlocked position with the pivotal locking lever about the rotational axis of the turret assembly; and
wherein the plurality of locked positions include a plurality of zero positions of the turret assembly.

Embodiment 24. A turret assembly for an optical sight, comprising:
a locking system including:
an unlocking collar assembly; and
a locking lever assembly;
wherein the locking lever assembly is configured to engage the unlocking collar assembly in a plurality of locked positions about a rotational axis of the turret assembly;
wherein the unlocking collar assembly is configured to be directed to a plurality of unlocked positions about the rotational axis of the turret assembly; and
wherein the plurality of locked positions include a plurality of zero positions of the turret assembly.

Although the present disclosure is described above in terms of various exemplary embodiments and implementations, it should be understood that the various features and functionality described in one or more of the individual embodiments are not limited in their applicability to the particular embodiment with which they are described, but instead might be applied, alone or in various combinations, to one or more other embodiments whether or not such embodiments are described and whether or not such features are presented as being a part of a described embodiment. Thus, the breadth and scope of the claimed invention should not be limited by any of the above-described embodiments.

Persons of ordinary skill in the art will recognize that many modifications may be made to the present disclosure without departing from the spirit and scope of the disclosure. The embodiment(s) described herein are meant to be illustrative only and should not be taken as limiting the invention, which is defined in the claims.

I claim:

1. A turret assembly for an optical sight, comprising:
a locking member; and
a locking surface for the locking member;
wherein the locking member is biased toward the locking surface;
wherein the locking surface is biased toward the locking member;
wherein the locking surface is adjustable about a rotational axis of the turret assembly and adjustable along the rotational axis of the turret assembly; and
wherein the locking member is adjustable about the rotational axis of the turret assembly and adjustable along the rotational axis of the turret assembly.

2. The turret assembly of claim 1, wherein the locking member includes a pivotal locking lever biased toward the locking surface.

3. The turret assembly of claim 1, wherein the locking surface includes a first radially disposed slot of an unlocking member configured to receive at least part of the locking member therein.

4. The turret assembly of claim 3, wherein the unlocking member is configured to be set to one or more locked positions with the locking member and configured to be set to one or more unlocked positions with the locking member.

5. The turret assembly of claim 4, wherein the unlocking member is configured as a manual adjustment member of the turret assembly.

6. The turret assembly of claim 5, wherein the unlocking member is configured as an attachment surface for a removable cap member.

7. The turret assembly of claim 3, further comprising an over travel stop member turnable about the rotational axis of the turret assembly, wherein the unlocking member includes at least a second radially disposed slot configured to receive at least part of the over travel stop member therein.

8. The turret assembly of claim 6, further comprising a housing for the pivotal locking lever, wherein the housing includes a contact surface for the over travel stop member.

9. The turret assembly of claim 4, wherein the one or more locked positions include one or more zero positions of the turret assembly.

10. The turret assembly of claim 3, wherein the unlocking member is configured to be set to a plurality of locked positions with the locking member and configured to be set to a plurality of unlocked positions with the locking member.

11. The turret assembly of claim 10, wherein the plurality of locked positions include a plurality of zero positions of the turret assembly.

12. A turret assembly for an optical sight, comprising:
a pivotal locking lever; and
an unlocking member comprising a locking surface for the pivotal locking lever;
wherein the pivotal locking lever is biased toward the unlocking member;
wherein the unlocking member is biased toward the pivotal locking lever;
wherein the unlocking member is adjustable about a rotational axis of the turret assembly and adjustable along the rotational axis of the turret assembly; and
wherein the pivotal locking lever is adjustable about the rotational axis of the turret assembly and adjustable along the rotational axis of the turret assembly.

13. The turret assembly of claim 12, wherein the unlocking member includes a locking slot for receiving at least part of the pivotal locking lever therein.

14. The turret assembly of claim 13, wherein the unlocking member is configured to be set to one or more locked positions with the pivotal locking lever and configured to be set to one or more unlocked positions with the pivotal locking lever.

15. The turret assembly of claim 14, wherein the unlocking member is configured as a manual adjustment member of the turret assembly.

16. The turret assembly of claim 15, wherein the unlocking member is configured as an attachment surface for a removable cap member.

17. A turret assembly for an optical sight, comprising:
a locking system including:
an unlocking collar assembly; and
a locking lever assembly;
wherein the locking lever assembly comprises a pivotal locking lever biased toward the unlocking collar assembly;
wherein the unlocking collar assembly comprises an unlocking collar biased toward the locking lever assembly; and
wherein the unlocking collar assembly may be set to one or more locked positions with the locking lever assembly and set to one or more unlocked positions with the locking lever assembly.

18. The turret assembly of claim 17, wherein the one or more locked positions include one or more zero positions of the turret assembly.

19. The turret assembly of claim 18, wherein the unlocking collar is configured as an attachment surface for a removable cap member.
